(19) United States
(12) Patent Application Publication
(10) Pub. No.: US 2005/0066366 A1
(43) Pub. Date: Mar. 24, 2005

(54) Receiving apparatus, method for displaying in conjunction with television program, and printing control method

(76) Inventor: Kouichi Takamine, Kawanishi-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/944,742

(22) Filed: Sep. 21, 2004

(30) Foreign Application Priority Data
Sep. 22, 2003 (JP) 2003-329527

(51) Int. Cl. H04N 5/445

(52) U.S. Cl. 725/59; 725/51

(57) ABSTRACT

A television receiver 2 includes: a television picture generation unit 200 that receives at least one television program broadcast including a URL which indicates a server 3 where a content 301 related to the television program broadcast is stored; a picture combination unit 300 that displays the received television program on a single screen; a modem 900 that receives the content 301 from the server 3 indicated by the URL included in the television program; and a control microcomputer 500 that changes the size of the picture of the television program to a predetermined size, and controls the picture combination unit 300 so as to continue displaying the television program picture, as a window on the screen, in front of the picture of the received content 301.

### BACKGROUND OF THE INVENTION

(1) Field of the Invention

The present invention relates to a receiving apparatus having a television broadcast receiving function, a method for displaying a television broadcast program and a Web page on the Internet in conjunction with each other (hereinafter referred to as “TV program-linked display”) in the receiving apparatus having the television broadcast receiving function, and a printing control method for a picture displayed on a television screen involving the TV program-linked display. The present invention aims at an apparatus such as a stationary television system, a portable television apparatus, a set top box and a personal computer having the television broadcast receiving function built therein.

(2) Description of the Related Art

The recent development in digital technology and information technology (IT) has driven the further increase in capacity of communication lines and digitalization of television broadcast. In addition, as a merger between broadcasting technology and communication technology has been accelerated, various types of apparatuses having both a broadcasting function and a communication function have been developed.

A typical example of such an apparatus is a television receiver having a WWW (World Wide Web) browser function.

As for the television receiver having the WWW browser function, the following technology has been already known. FIG. 1 is a block diagram showing a configuration of a conventional television broadcasting apparatus and a television receiver. In FIG. 1, a multiplexing unit 19 in a television broadcasting apparatus 8 multiplexes a URL (Uniform Resource Locator) 112 and a URL display instruction 119 on an inputted television signal 101. A transmission unit 12 transmits the television signal outputted from the multiplexing unit 19 to a television receiver 9.

The television picture generation unit 20 in the television receiver 9 receives the television signal transmitted from the television broadcasting apparatus 8, and generates a television picture based on the signal. The television picture generation unit 20 also performs filtering processing on the received television signal, and outputs a control stream obtained by the filtering processing to a control microcomputer 59 (hereinafter referred to as “a microcomputer”). This processing performed by the television picture generation unit 20 is widely known as the processing that is absolutely necessary for digital television receivers.

A URL display instruction obtainment unit 79 extracts the URL display instruction 119 multiplexed by the television broadcasting apparatus 8 from the control stream outputted from the television picture generation unit 20. Similarly, a URL obtainment unit 72 extracts the URL 112 multiplexed by the television broadcasting apparatus 8 from the control stream.

The microcomputer 59 executes various types of control processing in the television receiver 9. Upon receipt of the URL display instruction 119 from the URL display instruction obtainment unit 79, the microcomputer 59 executes an on-screen display control (hereinafter referred to as “OSD control”) in order to display the URL 112 obtained by the URL obtainment unit 72 on the screen. When a user instructs startup of a browser using a remote control while the URL is displayed on the screen, the microcomputer 59 starts the WWW browser processing. To be more specific, as the first step, the microcomputer 59 executes the communication protocol processing while controlling a modem 90 so as to receive, from a server 3 connected to the Internet 4, a content 102 that corresponds to the URL 112 obtained by the URL obtainment unit 72. Next, as the second step, the microcomputer 59 generates the browser picture based on the received content.

A picture combination unit 39 obtains a combined picture to be displayed on a monitor 40 based on the television picture generated by the television picture generation unit 20 and the browser picture generated through the WWW browser processing performed by the microcomputer 59. The picture combination unit 39 selects and outputs one of the television picture and the browser picture under the control of the microcomputer 59. Or, the picture combination unit 39 scales the size of the browser picture window down at a fixed rate using a fixed scaling unit 38 in order to obtain the picture to be displayed on the screen including both the television picture and the browser picture at the same time. In either case, the processing by the picture combination unit 39 is determined by the television receiver 9 in a fixed manner.

Taking, as an example, the case where a commercial message for a product “a” which is manufactured and marketed by a company A is broadcasted on television, a method for providing advertisements to the television receiver 9 and operation of the television receiver 9 will be explained below. It is assumed that the company A manages the server 3 connected to the Internet 4, and the content 102 for introducing the product “a” is stored in the server 3. The producer of a television program wants the user (viewer) of the television receiver 9 to access the content 102 when the commercial message of the product “a” is broadcasted. So, the television broadcasting apparatus 8 multiplexes the URL display instruction 119 and the URL 112 of the content 102 onto the inputted television signal 101 and broadcasts the multiplexed signal.

FIG. 2 is a flowchart showing the operation of the microcomputer 59 during receiving the television broadcast. In the initial state before receiving the commercial message, a television program shall be displayed on the monitor 40 of the television receiver 9. When the television broadcast is switched to the commercial of the product “a”, the television broadcasting apparatus 8 multiplexes the URL display instruction 119 and the URL 112 of the content 102 onto the inputted television signal 101 and transmits the multiplexed signal. By referring to FIG. 2, how the microcomputer 59 operates after the television receiver 9 receives the multiplexed television signal of these two kinds of data will be explained.

First, the microcomputer 59 obtains the URL display instruction 119 and the URL 112 respectively from the URL display instruction obtainment unit 79 and the URL obtainment unit 72 (Step S901). Next, the microcomputer 59 performs OSD control for displaying the obtained URL 112 on the screen (Step S902). At this time, the obtained URL 112, which is superimposed on the television picture, is displayed on the monitor 40. Seeing this screen picture, the viewer becomes aware of the existence of the content 102 related to the product “a”. When the viewer is interested in the product “a”, he/she inputs a browser startup command on the television receiver 9 using the remote control 80. On the contrary, when the viewer is not interested in the product “a”, he/she inputs a URL clear command on the television receiver 9 using the remote control 80. The microcomputer 59 checks the input from the remote control 80 (Step S903), and moves to Step S904 when the browser startup command is inputted, and moves to Step S908 when the URL clear command is inputted.

When the browser startup command is inputted, the microcomputer 59 receives the content 102 that corresponds to the obtained URL 112 from the server 3 connected to the Internet 4 (Step S904). Next, the microcomputer 59 instructs the picture combination unit 39 to display the received content on the monitor 40 in full-screen mode (Step S905).

Next, the microcomputer 59 generates a browser picture based on the received content (Step S906). The browser picture generated by the microcomputer 59 is delivered to the picture combination unit 39 and stored in the display plane (not shown in the diagram) managed by the picture combination unit 39. Since the picture combination unit 39 receives the full-screen display instruction in Step S905, it outputs the browser picture delivered from the microcomputer 59 as it is. Therefore, the browser picture is displayed on the monitor 40 in full-screen mode.

Then, the microcomputer 59 performs WWW browser processing (Step S907). While Step S907 is under the control of the microcomputer 59, the viewer can use the television receiver 9 as a WWW browser. When the browser end command is inputted during the execution of the WWW browser processing, the microcomputer 59 ends the WWW browser processing, which means the end of the processing involving the URL display instruction 119.

When the URL clear command is inputted in Step S903, the microcomputer 59 performs OSD control for clearing the displayed URL. In this case, the microcomputer 59 ends the processing for the obtained URL display instruction 119, without performing the WWW browser processing.

According to such a conventional television receiver, the WWW browser is started up based on the command inputted by the viewer, the browser picture cannot be displayed in conjunction with the television picture. In addition, display of the browser picture as a window of the television picture may impair the important part of the television picture. For example, the browser picture may overlap an object to be advertised even during broadcasting the commercial message.

In order to solve these problems of the conventional television receiver, an invention has been made. For example, Japanese Laid-Open Patent Application Publication No. 2003-78837 (Para. 1-19, FIG. 1 and FIG. 12) or the like discloses that display style information for determining the display style of the browser picture is obtained from the television signal and the browser picture is combined with the television picture for display according to the display style information. Accordingly, it becomes possible to display the combined picture of the browser picture and the television picture on the television screen according to the display style specified on the part of the television broadcaster

However, even the television receiver described in the above conventional art has the following problems. First, since the browser picture is combined with the television picture, a part of the television picture is lost by the area for displaying the browser picture.

In the case where the television picture and the browser picture are displayed so that they do not overlap each other, an unused area exists on the screen, which is inefficient use of the screen.

In addition, against the viewer's wish to view the browser picture of information related to the television program willingly as a result of his/her interest in the program, it is not possible to display the browser picture in a full-screen mode because the prime purpose of the conventional art is to display the television picture.

Furthermore, since the browser picture has to be displayed based on the display style specified on the part of the television broadcaster, the implementation of the browser function is limited only to the unified display styles for browser pictures.

### SUMMARY OF THE INVENTION

The present invention is conceived to solve the above problems, and an object of the present invention is to provide a receiving apparatus, a method for displaying in conjunction with a television program (TV program-linked display) and a printing control method involving the TV program-linked display that allow control over display of a browser picture and a television picture so that they are displayed in conjunction with each other (i.e., the television picture that is currently being viewed is continuously displayed without loss of the picture displayed on the screen even when the browser picture is started up on the current television picture) in order to display the television picture in front of the browser picture on the screen in a state where “entirety of picture display (complete picture display without losing any part of the picture)” of the television picture is maintained efficiently at least while the television program is being broadcasted.

In order to achieve the above object, the receiving apparatus of the present invention is a receiving apparatus that receives a plurality of information in different formats from different sources and displays the plurality of information, comprising: a first receiving unit operable to receive at least one first information that includes link information that indicates a location where second information related to the first information is stored; a displaying unit operable to display the received plurality of information on a single screen; a second receiving unit operable to receive the second information from the storage location indicated by the link information included in the displayed first information; and a control unit operable to change a size of a first information picture to a predetermined size, and control the displaying unit so as to continue displaying the first information picture, as a window on the single screen, in front of a second information picture, the first information picture being a picture displayed as the first information, and the second information picture being a picture displayed simultaneously as the received second information.

The present invention may be configured so that in the case where the second information is a structured document written in a language including HTML and XML and a display style of the first information and the second information is determined by specifying stack levels of the first information picture and the second information picture on the screen using a style sheet language including Cascading Style Sheets, Level 2, the control unit controls the displaying unit so that the stack level of the first information picture is larger than all the stack levels of the second information pictures on the screen.

According to this configuration, it becomes possible to control the picture display so that the first information is displayed in front of the second information by specifying the stack level of the style sheet language such as Cascading Style Sheets, Level 2 (CSS2).

The present invention may be configured so that the first receiving unit further receives a display control signal for controlling whether or not to display the first information in front of any other pictures on the screen, and the control unit causes the displaying unit to continue displaying the first information in front of any other pictures on the screen when the display control signal received from the first receiving unit indicates that the first information is to be displayed in front of any other pictures on the screen.

According to this configuration, the first information is displayed in front of any other pictures on the screen according to the display control signal received from the first receiving unit, so there is an effect that the broadcast station that transmits the first information, for example, can control display of the first information and the second information in the receiving apparatus.

It should be noted that the present invention may -be configured so that the receiving apparatus further includes a switching instruction input unit operable to accept a user's input that instructs switching between a normal display mode and a combined display mode, the normal display mode being a mode in which the displaying unit is caused to display only the received first information, and the combined display mode being a mode in which the displaying unit is caused to display selected second information behind the first information picture of the predetermined size when accepting the user's input that indicates selection of the second information to be received, wherein the control unit switches between the normal display mode and the combined display mode according to the switching instruction, and causes the displaying unit to display the second information behind the first information in the case where the second information to be received is selected in the combined display mode.

According to this configuration, in the receiving apparatus that receives and displays the information from at least from two sources, the first information can be displayed in front of any other pictures on the screen even if the screen display is switched from the first information to the second information. Therefore, the user can view the first information without interruption.

The receiving apparatus of the present invention may be configured so that the first receiving unit receives the first information and the display control signal via broadcast airwaves, the second receiving unit receives the second information from the storage location via a communication network, the control unit includes: a style information storage unit operable to previously hold second style information for placing the first information picture of the predetermined size in front of the received second information picture; a display size changing unit operable to change the size of the first information picture to the predetermined size based on the second style information; and a combination unit operable to generate a display picture by combining the first information picture of the predetermined size with the second information picture based on the second style information, and the control unit causes the displaying unit to display the display picture generated by the combination unit when the received display control signal indicates that the first information is to be displayed in front of the second information.

According to this configuration, in the receiving apparatus that displays, in conjunction with the broadcast program as the first information, the second information received from the communication network such as the Internet, only the broadcast program can be displayed based on the first style information multiplexed on the broadcast, while the broadcast program can always be displayed in front of any other pictures on the screen based on the previously stored second style information even when the screen picture is switched from the broadcast program to the combined picture of the program picture and the second information related thereto.

The receiving apparatus may further include a print data generation unit operable to generate print data from the display picture generated by the combination unit; and a printing control unit operable to control the generation of the print data by the print data generation unit based on a printing instruction from a user.

According to this configuration, the print data is generated only when the combination unit combines the broadcast picture and the browser picture. Therefore, it is possible not only to disable the printing of the broadcast picture alone, but also to control the printing so as to have the user print, together with the broadcast picture, the browser picture that the program production people want to offer to the user.

The present invention may be configured so that the first receiving unit receives the plurality of first information in order of time, the first style information indicates that a main picture is placed on the screen in full-screen mode, while a sub-picture is placed, as a window on the screen, in an area within the main picture and in front of the main picture, the main picture being one of the first information that is currently being received, and the sub-picture being another one of the first information that was displayed in the past, the second style information indicates that a main picture is placed on the screen in full-screen mode, while a plurality of sub-pictures are placed, as windows on the screen, in areas within the main picture which do not overlap each other and in front of the main picture, the main picture being the received second information, and the plurality of sub-pictures being the plurality of first information, and the combination unit changes only the main picture to a picture of another newly received second information in the case where said another second information is received based on the link information of any of the first information displayed as the sub-pictures when the second information as the main picture is displayed based on the second style information.

Furthermore, the present invention may be configured so that the first receiving unit receives the plurality of first information on different carrier waves, the first style information indicates that a main picture is placed on the screen in full-screen mode, while a sub-picture is placed, as a window on the screen, in an area within the main picture and in front of the main picture, the main picture being a predetermined one of the first information, and the sub-picture being another first information than the predetermined first information, the second style information indicates that a main picture is placed on the screen in full-screen mode, while a plurality of sub-pictures are placed, as windows on the screen, in areas within the main picture which do not overlap each other and in front of the main picture, the main picture being the received second information, and the plurality of sub-pictures being the plurality of the first information, and the combination unit changes only the main picture as another newly received second information in the case where said another second information is received based on the link information of any of the first information displayed as the sub-pictures when the second information as the main picture is displayed based on the second style information.

In the present invention, the link information may be a URL.

According to this configuration, in the receiving apparatus that displays, in conjunction with the first information that is the broadcast program, the second information such as the Web page on the Internet received via the communication network, there is no need to follow the troublesome steps of returning once to the display of one of the first information only from the display of the second information as a main picture combined with the first information as a sub-picture based on the link information to the first information, and then switching to the display of the second information combined with another first information. Even better, it is possible to directly switch the display of the second information only based on the link information (URL) displayed on the sub-picture of another first information than the first information combined with the second information which is currently displayed as the main picture.

The present invention may be configured so that the first information further includes combination information that indicates whether or not to combine the first information with the second information, and the combination unit combines said at least one first information with the second information so that the first information picture is placed, as a window on the screen, in an area within the second information picture in the case where the combination information indicates said at least one first information is to be combined with the second information.

According to this configuration, by transmitting, to the receiving apparatus, the first information including the combination information indicating whether or not to combine the second information picture and the first information picture, it is possible to control whether or not to combine the first information picture with the second information picture based on the combination information. Therefore, it becomes possible for the program broadcast production people to determine whether or not to combine the first information picture and the second information picture so as to control the combined display of the first information and the second information in reflecting the intention of the broadcast program production part.

The receiving apparatus may further include a print data generation unit operable to generate print data from the display picture generated by the combination unit; and a printing control unit operable to control the generation of the print data by the print data generation unit based on a printing instruction from a user.

According to this configuration, the print data is generated only when the combination information indicates the combination, so it is possible to disable the printing of only the broadcast picture as the first information. In addition, the broadcast picture as the first information is printed together with the browser picture as the second information when the broadcast picture is printed, it is possible to control the printing of the screen display so that the broadcast picture is always printed together with the browser picture that the program production people want to offer to the user, when he/she instructs the printing of the broadcast picture.

According to the receiving apparatus and the TV program-linked display method, there is an effect that it is possible to display the browser picture with “the entirety of display” of the television picture being maintained, namely, without any loss in the display of the television picture that the user is currently viewing, and to display the browser picture and the television picture in conjunction with each other.

In addition, according to the printing control method of the present invention, there is an effect that it is possible to enable the printing of the picture displayed on the screen when the television picture and the browser picture are displayed together and disable the printing when only the television picture is displayed, so as to restrict the printing of the original television picture (namely, to protect the copyright of the television picture).

It should be noted that the present invention can be realized not only as the above-mentioned receiving apparatus or a television broadcasting system having the television broadcast receiving function and the communication function, but also as a TV program-linked display method including the steps executed by the characteristic units included in the receiving apparatus or the television broadcasting system or as a printing control method for printing the picture displayed on the screen by the TV program-linked display method, or as a program for causing a computer to execute those steps. Needless to say, such a program can be distributed via a recording medium such as a CD-ROM and a transmission medium such as the Internet.

As further information about technical background to this application, the disclosure of Japanese Patent Application No. 2003-329527 filed on Sep. 22, 2003 including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 is a block diagram showing a configuration of a conventional television broadcasting apparatus and television receiver;

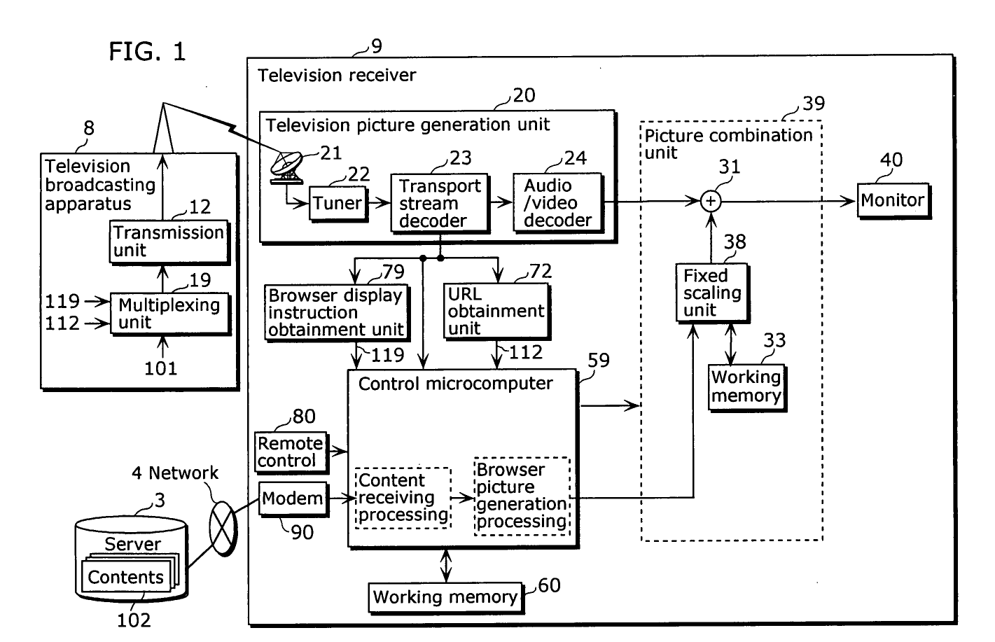

FIG. 2 is a flowchart showing the operation performed by the microcomputer when receiving television broadcast in the conventional art;

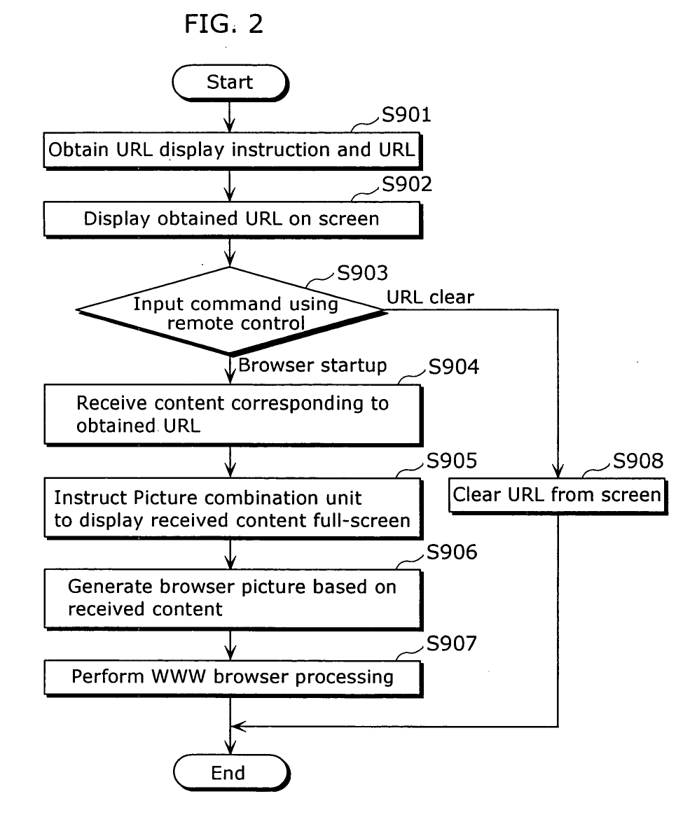

FIG. 3 is a block diagram showing a configuration of a television broadcasting apparatus and a television receiver according to a first embodiment of the present invention;

FIG. 4 is a diagram showing an example of a television picture displayed on the screen of the television receiver;

FIG. 5 is a diagram showing an example of a combined picture displayed on the screen of the television receiver, in which the browser picture is combined with the reduced television picture;

FIG. 6 is a flowchart showing the operation of the television broadcasting apparatus according to the first embodiment of the present invention;

FIG. 7 is a flowchart showing the operation performed by the microcomputer 500 after the television receiver 1 receives a television signal on which browser control data is multiplexed in the first embodiment of the present invention;

FIG. 8 is a diagram showing an example of a combined picture displayed on the screen, in which the browser picture of the Web page of a hotel is combined with the first TV picture of a travel program that is linked to the browser picture and currently being received and the second TV picture of a part of the picture displayed in the past in the same travel program;

FIG. 9A and FIG. 9B are diagrams showing examples where reduced television pictures that are related and unrelated to the current browser picture are combined with the browser picture. FIG. 9A shows a combined picture displayed on the screen, in which the reduced television pictures of a travel program (in the upper-left area on the browser picture) and a sport program (in the lower-right area on the browser picture) are combined with the Web page of an airline as the browser picture. FIG. 9B shows a combined picture displayed on the screen, in which the reduced television pictures of a sport program (in the upper-left area on the browser picture) and a travel program (in the lower-right area on the browser picture) are combined with the Web page of professional baseball as the browser picture;

FIG. 10 is a block diagram showing a configuration of a television broadcasting apparatus and a television receiver according to a second embodiment of the present invention;

FIG. 11 is a block diagram showing a specific configuration of a television broadcasting apparatus and a television receiver in the case where it is controlled during TV program-linked display whether or not to display a television picture with its entirety being maintained in front of any other pictures on the screen, based on a display control signal for controlling whether or not to display the television picture in the front;

FIG. 12A to FIG. 12C are diagrams showing examples of commercial display in the configuration for controlling whether or not to display the television picture in front of any other pictures on the screen based on the display control signal;

FIG. 13A to FIG. 13C are diagrams showing examples of weather forecast display in the configuration for controlling whether or not to display the television picture in front of any other pictures on the screen based on the display control signal; and

FIG. 14 is a diagram showing an example of stack level assignment with regard to the explanation of display styles and stacking of layers of pictures.

### DESCRIPTION OF THE PREFERRED EMBODIMENT(S)

The embodiments of the present invention will be explained in detail below with reference to the diagrams.

### First Embodiment

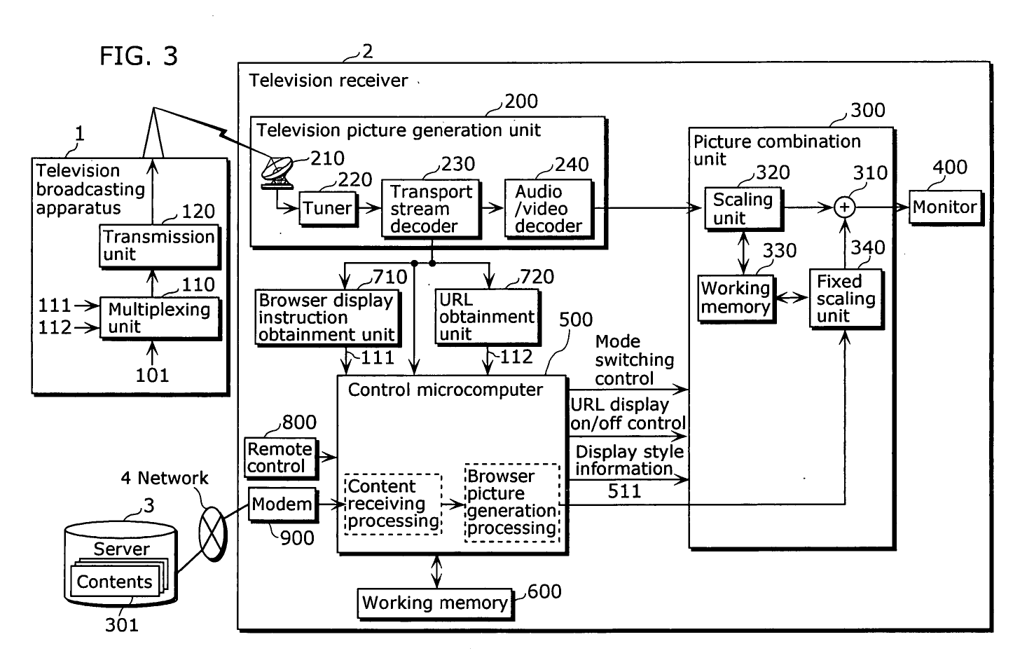

FIG. 3 is a block diagram showing a configuration of a television broadcasting apparatus and a television receiver according to the first embodiment of the present invention. In FIG. 3, a television broadcasting apparatus 1 includes a multiplexing unit 110 and a transmission unit 120. A television receiver 2 includes a television picture generation unit 200, a picture combination unit 300, a monitor 400, a microcomputer 500, a memory 600, a browser display instruction obtainment unit 710, a URL obtainment unit 720, a remote control 800 and a modem 900.

The television receiver 200 is connected to a network 4 in order to connect to the Internet. A server 3 that stores various types of contents 301 is connected to the network 4. The television receiver 2 has two functions: a function of receiving a television broadcast signal transmitted from the television broadcasting apparatus 1; and a function of displaying the contents 301 stored in the server 3 connected to the television receiver 2 via the network 4 on the screen (WWW browser function). It should be noted that only one server 3 is shown in FIG. 3 for simplification of the diagram, but a lot of servers are connected to a real network 4.

The television broadcasting apparatus 1 operates as follows. The multiplexing unit 110 multiplexes, onto the inputted television signal 101, the browser control data (a browser display instruction 111 and a URL 112) for controlling the WWW browser function of the television receiver 2. The transmission unit 120 transmits, to the television receiver 2, the television broadcast signal outputted from the multiplexing unit 110.

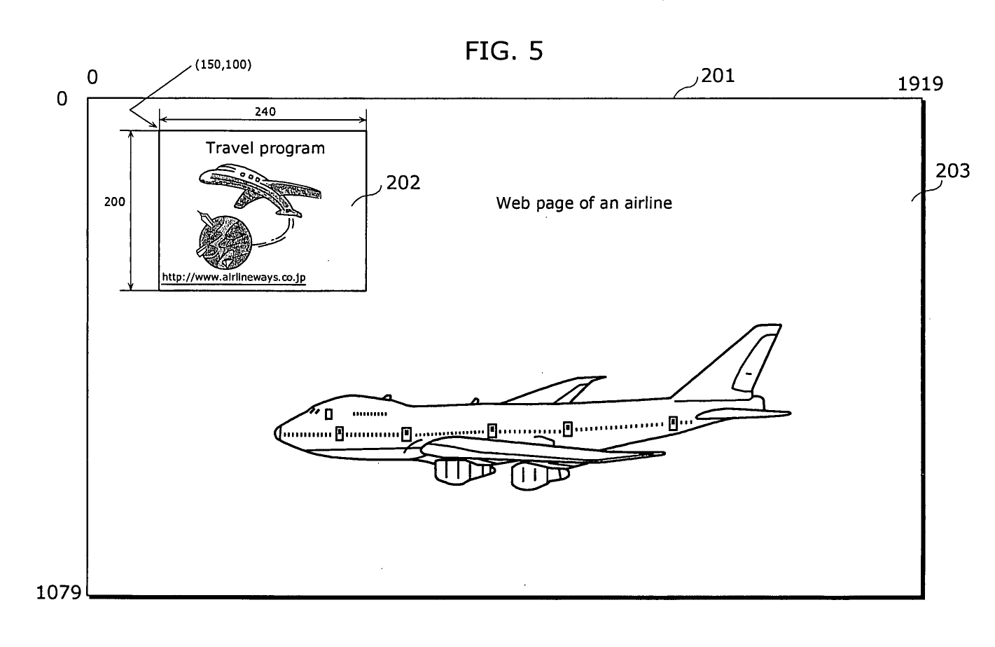

The television receiver 2 operates as follows, in general. The television picture generation unit 200 receives the television broadcast signal transmitted from the television broadcasting apparatus 1, and generates a television picture based on the received television broadcast signal. Upon receipt of the browser display instruction 111, the microcomputer 500 starts up the WWW browser. At this time, the microcomputer 500 receives, from the server 3, the content 301 that corresponds to the obtained URL 112, and generates the browser picture based on the received content 301. The picture combination unit 300 receives, from the microcomputer 500, the display style information 511 generated by the microcomputer 500. The picture combination unit 300 combines the television picture and the browser picture according to the display style information 511. As a result, the television picture is displayed as a window on the browser picture (See FIG. 5, for example) on the monitor 400 when the television picture display mode is switched to the browser picture display mode.

As mentioned above, the television broadcasting apparatus 1 transmits the television broadcast signal including the browser control data, whereas the television receiver 2 combines the television picture and the browser picture for display according to the browser control data.

In this regard, the television receiver 2 combines the browser picture and the television picture for display based on any of the display styles 511 which are previously stored in the microcomputer 500.

Next, each component of the television receiver 2 will be explained. The television picture generation unit 200 includes an antenna 210, a tuner 220, a transport stream decoder (hereinafter referred to as a “TS decoder”) 230 and an audio/video decoder 240 (hereinafter referred to as an “AV decoder”) 240. The antenna 210 receives digital television broadcast waves transmitted from the television broadcasting apparatus 1, and converts the received waves into electric signals and outputs them. The tuner 220 selects a signal in a predetermined frequency band from the signals outputted from the antenna 210, and demodulates the selected signal. As a result, the tuner 220 outputs a transport stream in conformity with the MPEG (Moving Picture Experts Group) standard.

The TS decoder 230 performs filtering processing on the transport stream outputted from the tuner 220, according to the MPEG standard. As already known, this filtering processing is performed using a program identifier (ID) or the like included in a PAT (Program Association Table) packet, a PMT (Program Map Table) packet or the like. Through this filtering processing, the transport stream is separated into an audio stream, a video stream and a control stream that includes packets concerning data broadcasting, above-mentioned browser control data and the like. The audio stream and the video stream are delivered to the AV decoder 240, whereas the control stream is delivered to the microcomputer 500.

The AV decoder 240 decodes the audio stream and the video stream outputted from the TS decoder 230 respectively, and outputs an audio signal and a video signal. The video signal obtained in the AV decoder 240 is delivered to the picture combination unit 300.

The picture combination unit 300 includes a combination unit 310, a scaling unit 320, a working memory 330 and a fixed scaling unit 340.

The fixed scaling unit 340 receives the browser picture generated by execution of the WWW browser processing by the microcomputer 500. Under the control of the microcomputer 500, the fixed scaling unit 340 performs the scaling processing for changing the display size of the browser picture to a predetermined size and the image conversion processing for converting the image format.

The scaling unit 320 receives the video signal from the AV decoder 240, and under the control of the microcomputer 500, performs the scaling processing for changing (scaling up or scaling down) the display size of the television picture that consists of the video signal and the image conversion processing for converting the image format.

The working memory 330 is a working memory for the scaling unit 320 and the fixed scaling unit 340. The television picture resized by the scaling unit 320 and the browser picture on which the image conversion processing is performed by the fixed scaling unit 340 are delivered to the combination unit 310.

Under the control of the microcomputer 500, the combination unit 310 combines the television picture resized by the scaling unit 320 with the browser picture on which the image conversion processing is performed by the fixed scaling unit 340. As a result, the browser picture including the television picture, as one window, is displayed on the monitor 400.

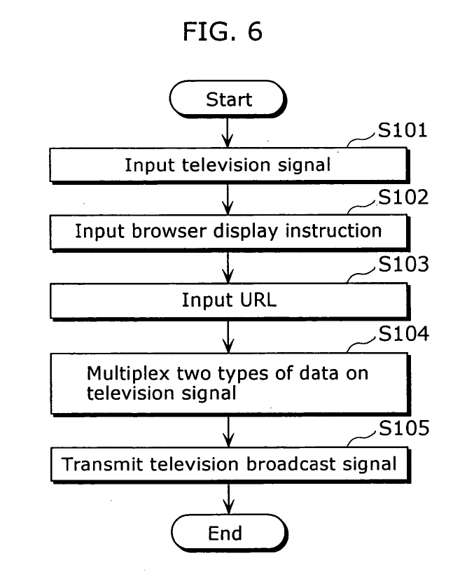

The microcomputer 500 executes various types of processing in the television receiver 2. The memory 600 is a working memory for the microcomputer 500, and stores the programs to be executed by the microcomputer 500 and various types of data. The microcomputer 500 executes the above-mentioned various types of processing by executing the programs stored in the memory 600. These various types of processing include content receiving processing, browser picture generation processing, operation input accepting processing and display control processing (See FIG. 6).

The browser display instruction obtainment unit 710 and the URL obtainment unit 720 are filtering circuits for extracting the browser control data from the control stream outputted from the TS decoder 230 to the microcomputer 500. The browser control data in the present embodiment includes the browser display instruction 111 and the URL 112. The browser display instruction 111 is an instruction to the television receiver 2 to start up the WWW browser and combine the television picture with the browser picture for display. The URL 112 is the URL of the content 301 to be combined and displayed together with the television picture.

The browser display instruction obtainment unit 710 extracts the browser display instruction 111 from the control stream. The URL obtainment unit 720 extracts the URL 112 from the control stream. Both of these browser control data extracted by these two filtering circuits are delivered to the microcomputer 500.

The remote control 800 is an input device operated by the user (viewer) of the television receiver 2. The viewer inputs various commands into the television receiver 2 using the remote control 800. The input device included in the television receiver 2 is not limited to the remote control 800, and it may be any type of an arbitrary apparatus operated by the viewer. For example, in the case where the television receiver is a personal computer having the television broadcast receiving function, a mouse or a keyboard can be used as an input device.

The modem 900 is connected to the communication line provided by a communication company. The modem 900 has a function of transmitting data to the communication line and a function of receiving the data from the communication line. Any type of a modem may be used as the modem 900 if only it has a function of modulating and demodulating a signal according to the modulation mode of the communication line. For example, the modem 900 may be a modem connected to a telephone line, an ADSL modem, or FTTHONU (Fiber To The Home Optical Network Unit) connected to an optical fiber network.

Next, the WWW browser function of the television receiver 2 will be explained. The microcomputer 500 performs the WWW browser processing by executing the WWW browser software. The WWW browser processing includes at least the content receiving processing and the browser picture generation processing. The WWW browser software executed by the microcomputer 500 may be software that is available in the market or software specially for the television receiver 2.

The content receiving processing, out of the WWW browser processing, is the processing for receiving the content 301 from the server 3 connected to the Internet via the network 4. In the content receiving processing, the microcomputer 500 receives the content 301 stored in the server 3 by performing the processing for controlling the modem 900 and the communication protocol processing such as TCP/IP (Transmission Control Protocol/Internet Protocol). The received content is stored in the memory 600.

It should be noted that the server 3 is sometimes referred to as a WWW server of a web server, and the content 301 is sometimes referred to as a web content or a web page. The content 301 includes various types of data files such as an HTML (Hyper Text Markup Language) file, an image file and a text file. The content 301 is identified using the URL including the server name and the file name. The URL is assigned to each content 301 and corresponds to the content identification information.

Out of the WWW browser processing, the browser picture generation processing is the processing for generating a browser picture based on the received content. In the browser picture generation processing, the microcomputer 500 first decodes the image file and text file included in the received content according to the property of each file. The decoding result is written into the memory 600. Next, the microcomputer 500 obtains the values of respective pixels that make up the browser picture images based on the decoding result, by referring to the HTML file included in the received content. The browser picture is generated by these two types of processing. The generated browser picture is delivered to the combination unit 300 for combining the pictures, and stored in the display plane (not shown in the diagram) managed by the combination unit 300.

In the WWW browser processing, it is also possible to decode not only a content including still images but also a content including moving images so as to generate a browser picture including moving images. The function of reproducing such a content including moving images is referred to as a streaming reproduction function. When combining a television picture with a browser picture, the broadcast-type information written in BML (Broadcast Markup Language) may be converted into the information written in XHTML (extensible Hyper Text Markup Language) so as to combine the browser picture and the television picture on an XHTML basis. For that purpose, the streaming reproduction function may be used for reproduction of the combined picture because the television picture includes moving images.

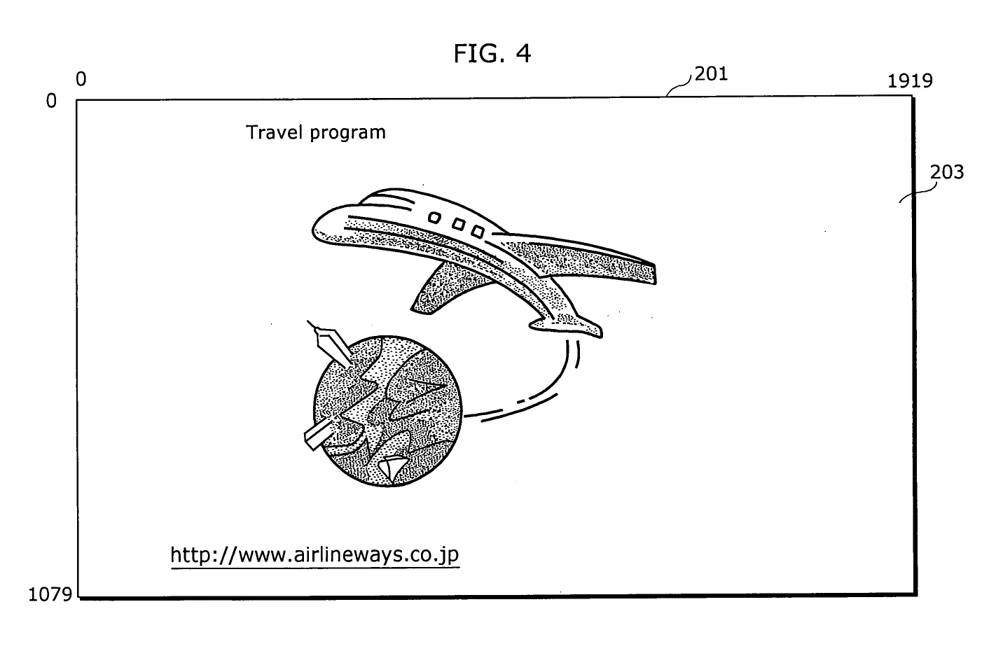

Next, the details of the display style information 511 will be explained with reference to FIG. 4 and FIG. 5. FIG. 4 is a diagram showing an example of a television picture displayed on the screen of the television receiver 2. FIG. 5 is a diagram showing an example of a combined picture displayed on the screen of the television receiver 2, in which the reduced television picture is combined with the browser picture.

The example of the television picture as shown in FIG. 4 is a picture of a travel program. The URL that is the information related to the program is displayed at the lower left on the screen. This URL is displayed when the related information exists, and even if the related information exists, the user can instruct not to display the URL using the remote control 800 or the like.

When the user instructs the microcomputer 500 to perform the WWW browser processing using an instruction means such as a remote control, the microcomputer 500 accesses the provider of the related information indicated by the URL in FIG. 4 and downloads the corresponding content. Then, the microcomputer 500 performs the WWW browser processing on the downloaded content so as to generate the browser picture. FIG. 5 is obtained by combining the generated browser picture and the reduced television picture based on the display style information 511.

In FIG. 4 and FIG. 5, the size of the display screen 201 is 1920 pixels wide×1080 pixels high. As shown in FIG. 5, the size of the television picture 202 combined with the browser picture 203 shall be 240 pixels wide×200 pixels high. In addition, in the 2D coordinate system with the upper-left vertex as a point of origin, the television picture 202 is placed so that the upper left vertex thereof is positioned 150 pixels rightward and 100 pixels downward from the point of origin.

In order to obtain the display screen 201 by combining the television picture 202 with the browser picture 203, where on the browser picture 203 the television picture 202 is to be placed is determined. Considering that the television picture 202 is a rectangle, it is necessary to determine how the television picture 202 is placed in a rectangular area on the browser picture 203. There are two methods for representing this rectangular area: the first method using the position of one of the vertices and the lengths of two sides of the rectangle; and the second method using two origin points of the rectangle. In the first method, the display style information 511 for the browser picture includes the coordinate of the upper-left vertex (150, 100) of the rectangular area where the television picture 202 is placed and the lengths of two sides 240 and 200 of the rectangle. In the second method, the display style information 511 for the browser picture 203 includes the coordinate of the upper-left vertex (150, 100) and the coordinate of the lower-right vertex (390, 300) of the rectangular area where the television picture 202 is placed.

Next, the operation of the television broadcasting apparatus 1 will be explained with reference to FIG. 6. FIG. 6 is a flowchart showing the operation of the television broadcasting apparatus. First, the television signal 101 is inputted to the multiplexing unit 110 in the television broadcasting apparatus 1 (Step S101 in FIG. 6). The television signal 101 inputted in Step S101 is a transport stream obtained by multiplexing an audio signal and a video signal that make up a television program.

Then, the browser control data for controlling the WWW browser function of the television receiver 2 is inputted to the multiplexing unit 110 (Steps S102 and S103 in FIG. 6). To be more specific, to the multiplexing unit 110, the browser display instruction 111 is inputted in Step S102, whereas the URL 112 is inputted in Step S103.

Next, the multiplexing unit 110 multiplexes the two types of browser control data inputted in Steps S102 and S103 onto the television signal 101 inputted in Step S101 (Step S104 in FIG. 6). The multiplexed television signal obtained in Step S104 is delivered to the transmission unit 120. The transmission unit 120 transmits the television signal including two types of browser control data to the television receiver 2 (Step S105 in FIG. 6). To be more specific, the transmission unit 120 modulates a predetermined carrier wave based on the television signal outputted from the multiplexing unit 110, and transmits the modulated carrier wave in the form of a radio wave.

It should be noted that an arbitrary method may be used for multiplexing the browser control data onto the transport stream in Step S104. For example, as a method for multiplexing the browser display instruction 111, there is a method for multiplexing it by writing it in a script language such as an ECMA (European Computer Manufacturers Association) script used for data broadcasting. As a method for multiplexing the URL 112, there is a method for multiplexing it as an identifier of a program schedule information such as EIT (Event Information Table) and SDT (Service Description Table), in addition to the method for multiplexing it by writing it in a script language.

The browser control data is obtained in the following manner. It is assumed, for example, that the producer of a television program wants the viewers to access the Web page of an object to be advertised that appears on the television pictures. In this case, it is examined whether or not the object to be advertised appears in respective television pictures that make up the television program after the television program is produced, and it is determined where on the television pictures the URL, that is the address (location) of the information relevant to the object that appears on the television picture, should be placed for display. For that purpose, where the URL should be displayed is determined based on the layout of the television picture elements so that the television picture is not overlapped by the URL. For example, if the television picture is a commercial message, the display position of the URL is determined based on the position of the object to be advertised that appears on that television picture so that the URL does not overlap the object.

It should be noted that the object to be advertised may be not only tangible products (such as consumer electric appliances, passenger cars, foodstuffs and cosmetics), but also intangible services (such as banking, travel handling, transport and communication). The companies (such as consumer electronics manufacturers, auto manufacturers, banks and travel agencies) that are the sponsors of the objects to be advertised manage the servers 3 connected to the network 4. The contents that introduce the objects to be advertised or the contents of the sponsor companies themselves are stored in the servers 3.

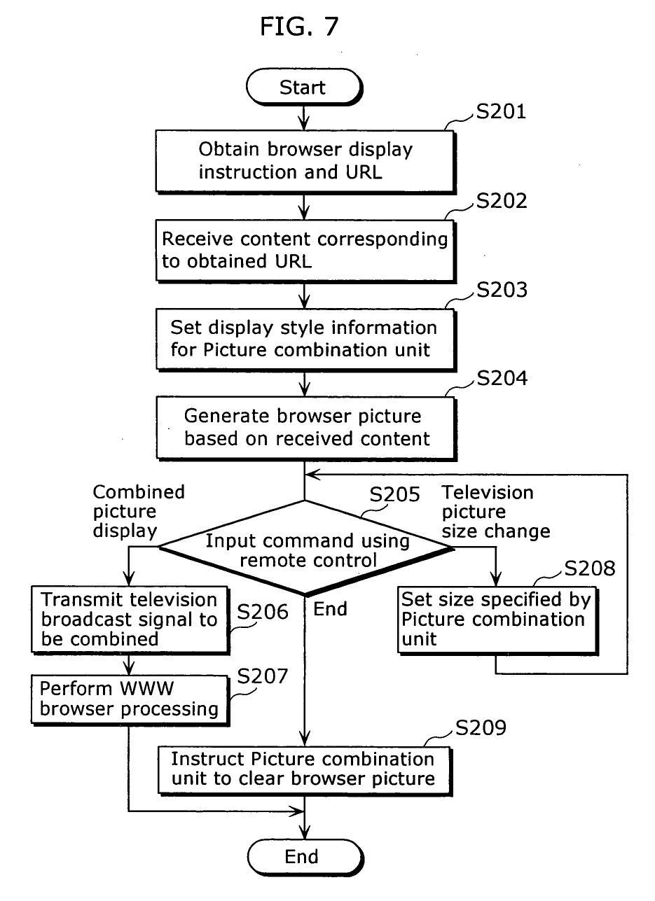

Next, the operation of the television receiver 2 will be explained with reference to FIG. 7. The following explanation shows an example of the operation for displaying the URL of the content of a travel agency that handles tours and the like related to a travel program which is being broadcasted. It is assumed that a company A manages the server 3 connected to the network 4, and the content of the travel agency related to the travel program is stored in the server 3.

While the TV program linked to the content owned by the travel company is being broadcasted, the producer of the program wants the viewers to access the content. So, when the program on the air has come to show the scene related to the content of the travel agency, the television broadcasting apparatus 1 multiplexes the browser display instruction 111 and the URL 112 onto the inputted television signal 101 and transmits the multiplexed signal. FIG. 7 is a flowchart showing the operation performed by the microcomputer 500 after the television receiver 1 receives the television signal on which these browser control data are multiplexed.

The browser display instruction obtainment unit 710 extracts the browser display instruction 111 from the control stream outputted from the TS decoder 230, and outputs it to the microcomputer 500. Similarly, the URL obtainment unit 720 extracts the URL 112 from the control stream, and outputs it to the microcomputer 500.

The microcomputer 500 first obtains the browser display instruction 113 and the URL 112 (Step S201 in FIG. 7). Upon receipt of the browser display instruction 111, the microcomputer 500 recognizes it as an instruction to start up the WWW browser, and performs the processing following Step S202.

Next, the microcomputer 500 receives, from the server 3, the content 301 that corresponds to the URL 112 obtained in Step S201 (Step S202). To be more specific, the microcomputer 500 starts the execution of the WWW browser software immediately after receiving the browser display instruction, and controls the modem 900 as well as executes predetermined communication protocol processing such as TCP/IP. The microcomputer 500 accesses the server 3 indicated under the host name of the URL 112 obtained in Step S201, and receives, from the server 3, the content 301 specified under the file name of the URL 112. The content 310 received in Step S202 is stored in the memory 600.

Next, the microcomputer 500 sets, for the picture combination unit 300, the display style information 511 previously held in itself (Step S203 in FIG. 7). The display style information 511 includes the information of a rectangular area on the browser picture where the television picture is to be placed. After the execution of Step S203, the picture combination unit 300 combines the television picture with the browser picture based on the information of this rectangular area. In other words, the picture combination unit 300 changes the size of the television picture so as to fit it into the rectangular area, and then combines the resized television picture with the browser picture.

Next, the microcomputer 500 generates the browser picture based on the content received in Step S202 (Step S204). To be more specific, the microcomputer 500 decodes the image file and text file included in the received content according to the property of each file by executing the WWW browser software, and writes the decoding result into the memory 600. Then, the microcomputer 500 obtains the values of respective pixels that make up the browser picture based on the decoding result by referring to the HTML file included in the received content. The browser picture generated in Step S204 is delivered to the picture combination unit 300.

Then, the URL is displayed on an appropriate place on the television picture. The viewer finds out that there exists the content related to the program at this time, and inputs, into the television receiver 2, the command for displaying the combined picture of the reduced television picture and the browser picture, using the remote control 800 (Step S205 in FIG. 7: Combined picture display). At the same time, the viewer may input, into the television receiver 2, the command for changing the size of the television picture, using the remote control 800, so as to change the size of the television picture from the default size based on the display style information set in Step S203 (Step S205 in FIG. 7: Television picture size change). This affords convenience to the viewer because he/she can change the size of the television picture to be combined with the browser picture appropriately. If the viewer feels no interest in the TV program-linked content, he/she inputs the end command into the television receiver 2 using the remote control 800 (Step S205 in FIG. 7: End).

The microcomputer 500 checks the input from the remote control 800, and moves to Step S206 when the combined picture display command is inputted, moves to Step S208 when the television picture size change command is inputted, and moves to Step S209 when the end command is inputted (Step S205).

When the combined picture display command is inputted, the microcomputer 500 instructs the picture combination unit 300 to display the combined picture in order to combine the reduced television picture with the picture of the received content for display (Step S206 in FIG. 7). Then, the microcomputer 500 performs the WWW browser processing (Step S207 in FIG. 7). During the execution of the WWW browser processing by the microcomputer 500 in Step S207, the viewer can use the television receiver 2 as a browser screen on which he/she can also view the reduced television picture simultaneously. When the combined picture display end command is inputted during the execution of the WWW browser processing, the microcomputer 500 ends the processing based on the WWW browser display instruction 111.

When the size change command is inputted, the microcomputer 500 sets for the picture combination unit 300 the size specified by the size change command in order to fit the size of the television picture to be combined with the browser picture into the size specified by the viewer (Step S208 in FIG. 7). After Step S208 is executed, the picture combination unit 300 changes the size of the television picture so as to fit it into the specified size, and then combines the resized television picture with the browser picture (from Step S208 to Step S205 in FIG. 7).

When the end command is inputted, the microcomputer 500 instructs the picture combination unit 300 to clear the browser picture in order to return to the normal television picture display (Step S209 in FIG. 7). After executing Step S209, the picture combination unit 300 outputs the television picture generated by the television picture generation unit 200. After Step 5209, the microcomputer 500 ends the processing based on the browser display instruction 111 without performing the WWW browser processing.

It should be noted that the television broadcasting apparatus 1 may multiplexes, onto the inputted television signal 101, the browser display end instruction for the end of the browser function as browser control data. In this case, the television receiver 2 further includes a browser display end instruction obtainment unit for extracting the browser display end instruction from the control stream outputted from the TS decoder 23. In the case where the microcomputer 500 obtains the browser display end instruction from the browser display end instruction obtainment unit before receiving the input from the remote control 800 in Step S205, it moves to Step S209 in the same manner as the case where the end command is inputted from the remote control 800.

As described above, in the present embodiment, the television broadcasting apparatus transmits the television signal including browser control data, whereas the television receiver combines the television picture with the browser picture for display according to the browser control data. Particularly, the television receiver controls the microcomputer 500 based on the browser control data multiplexed by the television broadcasting apparatus, and combines the reduced television picture with the browser picture for display according to the display style information previously set for the television receiver. As a result, it becomes possible to reduce the size of the entire television picture and always display the entire television picture in a predetermined area on the browser picture even if the display is switched to the browser picture display.

Immediately after receiving the browser display instruction, the television receiver starts the WWW browser processing, so it becomes possible to display the browser picture with which the reduced but entire television picture is combined in conjunction with the television broadcast.

Furthermore, it is assumed that as a display style information of the browser picture, the television receiver 2 previously holds the description indicating at least that the reduced television picture is superimposed in a specified area on the browser picture for display. Therefore, it is possible to always display the entire television picture even if the size thereof is reduced, while the browser picture is displayed. In other words, higher priority is given to the television picture display on the television receiver, so it is possible to always display the entire television picture even during the display of the browser picture.

In the present embodiment, it is assumed that the television receiver holds the display style for television picture combination during the display of the browser picture. However, the display style for television picture combination may be predetermined so that the server 3a can create the content 301 based on the display style. By doing so, it is possible to realize the optimum layout on the browser picture without being overlapped by the television picture.

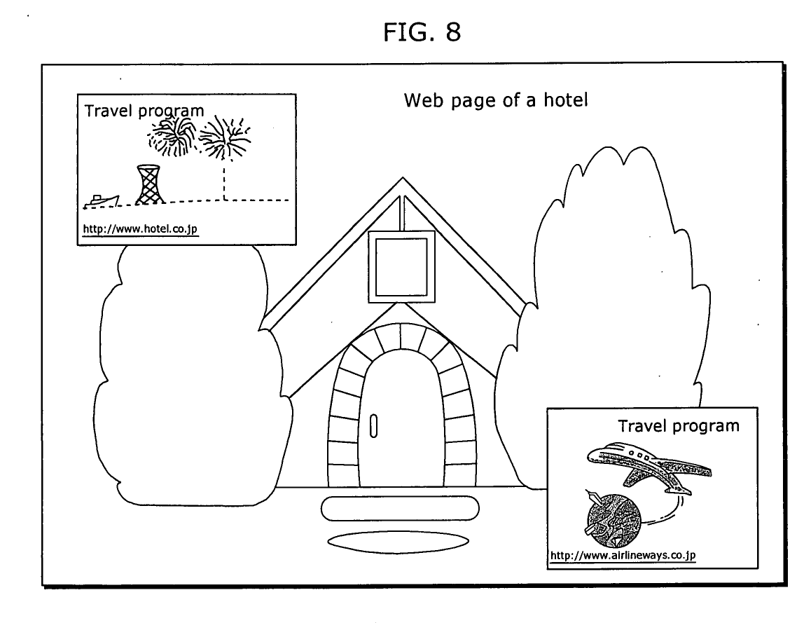

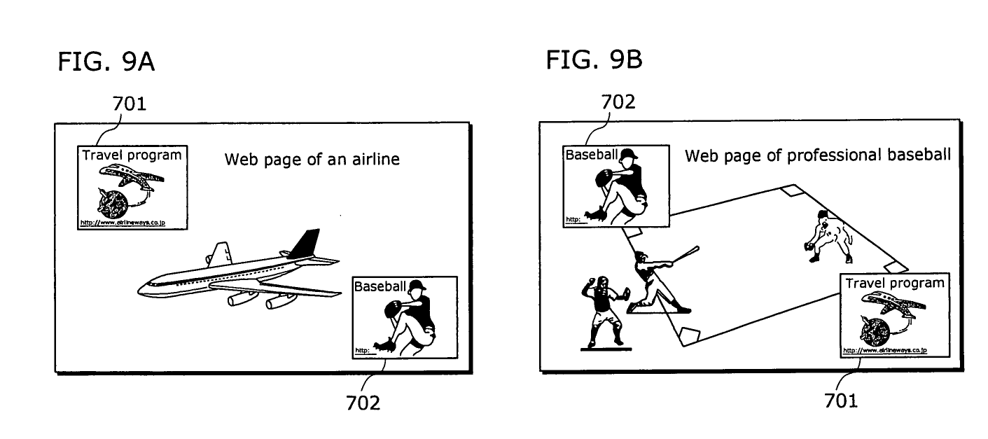

The present embodiment describes the case where the reduced television picture related to the browser picture is displayed on the browser picture without interruption, but the present invention is not limited to this case. For example, another reduced picture which a user is interested in but is not directly related to the current browser picture, such as a reduced television picture on another channel or a reduced part of a television picture displayed in the past, may be displayed in another area on the browser picture, as well as the reduced browser-related television picture displayed in the predetermined area thereon. Hereinafter, the reduced television picture related to the current browser picture will be referred to as “the first TV picture”, whereas the reduced television picture on another channel or the reduced part of the television picture displayed in the past will be referred to as “the second TV picture”. For example, on the second TV picture, the URL of the content indicating the link to the Web page on the Internet related to the second TV picture is displayed, and the related browser picture is displayed by obtaining the content based on this link. The following describes a specific example where a browser picture is switched to a combined picture in which a television picture that is directly related to the current browser picture and a television picture that is not directly related thereto are combined with the browser picture, with reference to FIG. 8 and FIG. 9.

FIG. 8 is a diagram showing an example of a combined picture displayed on the screen, in which the browser picture of the Web page of a hotel is combined with the first TV picture of a travel program that is linked to the browser picture and currently being received and the second TV picture of a part of the picture displayed in the past in the same travel program. In this diagram, the first TV picture that is currently being received is reduced and displayed in the upper-left area on the browser picture, whereas the second TV picture that is a part of the television picture displayed in the past is reduced and displayed in the lower-right area thereon. In the case where the link to the Web page of the airline in which the user is interested has been displayed when he/she was viewing a travel program before the picture (the URL of the Web page of a hotel) as shown in FIG. 8 is displayed, the displayed part of the travel program (See FIG. 4) shall be recorded on a memory such as the working memory 330, a video recorder connected to the television receiver externally, or the like. Then, the program contents have changed as time goes by, and a travel to another region than the region introduced in the recorded part of the same travel program, for example, is introduced. At this time, the first TV picture, which is reduced and displayed on the upper-left area in FIG. 8, is displayed in full-screen mode on the monitor 400, although it is not shown in the diagram. On the first TV picture, the URL (http://www.hotel.co.jp, for instance) of the Web page of the hotel introduced in the program is displayed, for example. If the user previously sets the mode, the recorded second TV picture is reduced and displayed in the lower-right area on the picture in conjunction with first TV picture of the current travel program. On the second TV picture, the URL (http://www.airlineways.co.jp, for instance) of the Web page of the airline is displayed. Under this state, if the user specifies either the first TV picture or the second TV picture (the first TV picture is specified in FIG. 8), using a remote control, so as to instruct the display of the Web page linked to the specified television picture, the combined picture is displayed as shown in FIG. 8. In FIG. 8, the Web page of the hotel obtained from the URL on the first TV picture is displayed in the browser display mode, and the first TV picture which has been displayed in full-screen mode just before the display of the Web page is reduced and displayed in the upper-left area on the browser picture. In FIG. 8, the reduced first and second TV pictures are combined and placed in the areas that do not overlap each other on the full-screen browser picture, and displayed in front of the browser picture. Under this state, if the user further instructs the display of the Web page indicated by the URL displayed on the second TV picture using the remote control or the like, the microcomputer 500 obtains, from the server 3, a file of the Web page of the airline indicated by the URL “http://www.airlineways.co.jp” on the second TV picture, and updates the picture display from the Web page of the hotel which has been displayed just before the user's instruction to the obtained Web page of the airline.

As described above, by displaying the reduced first and second TV pictures on the browser picture, the user can view the Web page indicated by the URL displayed on the second TV picture (a part of the television picture displayed in the past) on the browser picture while viewing continuously the first TV picture which is now being received. In addition, according to the television receiver 2 of the present invention, it is possible to directly switch the current browser picture display into another browser picture display without returning the full-screen display of the first TV picture. Therefore, the procedure for switching the browser picture display is easy and convenient. On the other hand, in the case where the picture is switched from the reduced display to the full-screen display, the target image is likely to be displayed in another position than the original one. Even in this case, the television receiver 2 of the present invention allows direct switching from the current browser picture to another browser picture without returning to the full-screen display of the first TV picture, so the user can continue viewing the first TV picture without interruption and turning his/her eyes. Therefore, it is possible to reduce the risk of losing sight of the target image in the picture, for example. It should be noted that as for the display of the second TV picture, a still picture specified by the user from among a plurality of previously recorded pictures may be displayed, or a plurality of recorded pictures may be displayed in order of appearance. Furthermore, in the present embodiment, the second TV picture is reduced and displayed in front of the full-screen first TV picture, but the present invention is not limited to such display, and the second TV picture may be displayed only after the browser is started up. In this case, the second TV picture is (1) reduced and displayed in the lower-right area on the browser picture by the user's remote control operation, or (2) reduced and displayed automatically in the lower-right area on the browser picture by the user's previous setting of the mode, when the browser is started up on the first TV picture.

FIG. 9A is a diagram showing a combined picture displayed on the screen, in which the reduced television pictures of a travel program (in the upper-left area on the browser picture) and a sport program (in the lower-right area on the browser picture) are combined with the Web page of an airline as the browser picture. FIG. 9B is a diagram showing a combined picture displayed on the screen, in which the reduced television pictures of a sport program (in the upper-left area on the browser picture) and a travel program (in the lower-right area on the browser picture) are combined with the Web page of professional baseball as the browser picture. The TV picture 701 of the travel program and the TV picture 702 of the sport program which are respectively reduced and displayed in FIG. 9A and FIG. 9B are the television pictures of the programs which are received simultaneously in parallel by two tuners, for example. In other words, in both FIG. 9A and FIG. 9B, the reduced television picture which is related to the current browser picture is displayed in the upper-left area on the browser picture, whereas the reduced television picture which is not directly related to the current browser picture is displayed in the lower-right area thereon. If the user instructs the microcomputer 500, using the remote control 800, to display the Web page of professional baseball based on the URL of that Web page superimposed on the TV picture 702 of the sport program, the display as shown in FIG. 9A is switched to the display as shown in FIG. 9B.

As a result, it is possible to display a new browser picture not only from the television picture which is directly related to the current browser picture but also based on the URL of the television picture on another channel that is superimposed and displayed on the current browser picture. In addition, the television picture which is directly related to the current browser picture is always reduced and displayed in the upper-left area and another television picture on another channel is always reduced and displayed in the lower-right area, there is an effect that the user can easily understand the relation between the current browser picture and these two television pictures. Furthermore, the user can directly access the desired browser picture without carrying out the step of accessing the television picture on another channel after returning the current browser picture to the full-screen display of the television picture, so it is easy to handle and convenient for the user.

Or, it is possible to incorporate combination information indicating whether to combine a broadcast-type picture with a browser picture or not into browser control data to be multiplexed onto a television signal so as to control whether or not to combine the broadcast picture with the browser picture based on this combination information. To be more specific, when multiplexing the browser control data onto the television signal, the television broadcasting apparatus 1 also multiplexes the combination information indicating whether or not to combine the broadcast-type information with the browser picture together with the browser control data. Then, the combination information obtainment unit 730 in the television receiver 2 extracts the combination information from the control stream outputted from the TS decoder 230 to the microcomputer 500. In the case where the extracted combination information indicates that the broadcast-type picture should be combined, the microcomputer 500 controls the combination unit 300 so as to combine at least one broadcast-type picture with the browser picture. On the contrary, in the case where the extracted combination information indicates that the broadcast-type picture should not be combined, the microcomputer 500 controls the combination unit 300 not to combine the broadcast-type picture with the browser picture.

It is possible, under the above configuration, to set whether or not to combine the television picture with the browser picture on the part of the broadcaster of the television signal, so it is possible to control whether or not to combine the television picture with the browser picture by reflecting the program producers' and sponsors' intentions. To be more specific, in the case where there is little need to combine program information when outputting related information, for example, in the case where output of the information related to a heavily commercialized program offers the sponsors more benefits, the program information is not combined. On the other hand, in the case where the program information is more important and should be always outputted when outputting related information, the program information is combined with the related information. By doing so, it becomes possible to control at the appropriate times whether or not to combine the program information with the related information according to the intensions on the part of television broadcasters.

(Control of Picture Display for Displaying a Television Picture in Front of Any Other Pictures on the Screen Based on a Display Control Signal)

The above present embodiment describes the case where the television receiver previously holds the style information for combination of a browser picture and a television picture while ensuring the entirety of the television picture, but the present invention is not limited to this case. For example, it is also possible to transmit the style information for TV program-linked display together with the television broadcast data from the television broadcasting apparatus.

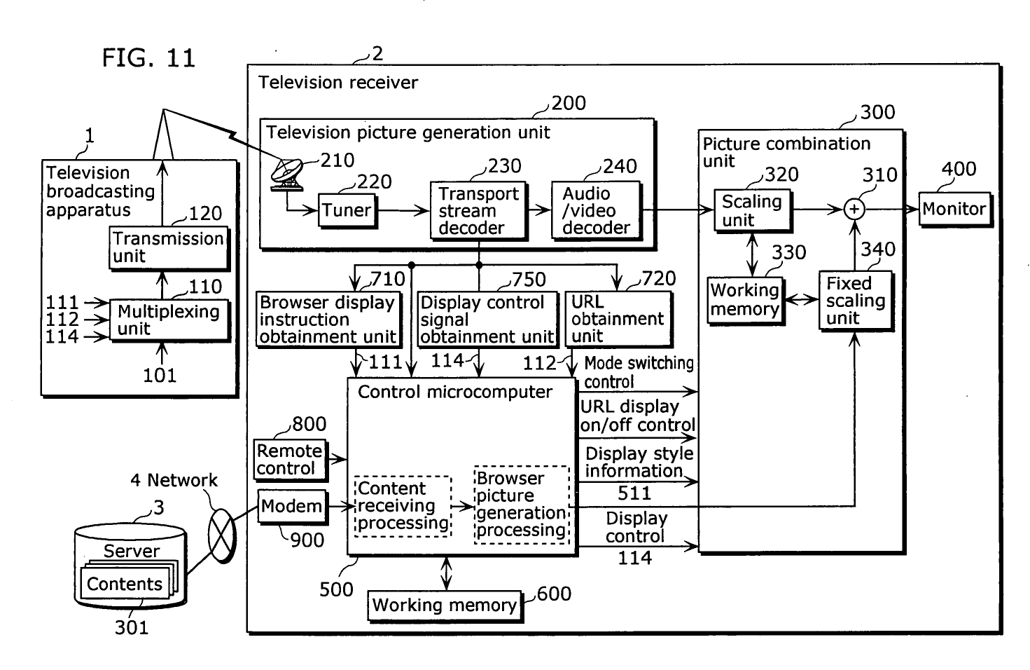

In addition, for TV program-linked display, the television receiving apparatus may control whether or not to display the television picture in its entirety in front of any other pictures on the screen, based on the display control signal transmitted from the television broadcasting apparatus for controlling whether or not to display the television picture in front of any other pictures on the screen. FIG. 11 shows a specific configuration of the television broadcasting apparatus 1 and the television receiver 2 in this case.

The case where whether or not to display the television picture in front of any other pictures on the screen is controlled based on the display control signal will be explained with reference to FIG. 11. Here, in FIG. 11, the same reference numbers are assigned to the same components as those in FIG. 3, and the explanation of the same functions is not repeated here.

As shown in FIG. 11, the multiplexing unit 110 of the television broadcasting apparatus 1 multiplexes the browser control data (the browser display instruction 111 and the URL 112) and the display control signal 114 for controlling the WWW browser function of the television receiver 2 onto the inputted television signal 101. The transmission unit 120 transmits, to the television receiver 2, a television broadcast signal outputted from the multiplexing unit 110.

The television receiver 2 operates in the following manner in general. The television picture generation unit 200 receives a television broadcast signal transmitted from the television broadcasting apparatus 1, and generates a television picture based on the received television broadcast signal. Upon receipt of the browser display instruction 111, the microcomputer 500 starts up the WWW browser. At this time, the microcomputer 500 receives from the server 3 the content 301 that corresponds to the obtained URL 112, and generates the browser picture based on the content 301. The picture combination unit 300 receives from the microcomputer 500 the display style information 511 generated by the microcomputer 500. This display style information 511 defines the style of the browser picture in consideration of the display area for the television picture to be displayed in its entirety, when the display control signal 114 indicates that the television picture is to be displayed in front of the browser picture.

The picture combination unit 300 combines the television picture and the browser picture based on the display style information 511. Therefore, the television picture in its entirety is displayed in front of the browser picture on the monitor 400 when the television picture display mode is switched to the browser picture display mode.

As mentioned above, the television broadcasting apparatus 1 transmits the television broadcast signal including the browser control data and the display control signal, whereas the television receiver 2 controls the picture display so that the television picture and the browser picture are displayed in conjunction with each other, based on the browser control data and the display control signal.

In this regard, when the television receiver 2 combines the television picture in its entirety with the browser picture for display based on the display style information 511 previously stored in the microcomputer 500, when the display control signal indicates that the television picture is to be displayed in front of the WWW browser picture.

Next, the operation of respective components included in the television receiver 2 in FIG. 11 but not included in the television receiver 2 in FIG. 3 will be explained below.

The TS decoder 230 performs filtering processing on the transport stream outputted from the tuner 220 according to the MPEG standard. This filtering processing separates the transport stream into an audio stream, a video stream and a control stream including packets for data broadcasting, above-mentioned browser control data and display control signal. This control stream is delivered to the microcomputer 500.

The microcomputer 500 executes various types of processing in the television receiver 2. The memory 600 is a working memory for the microcomputer 500, and holds the programs executed by the microcomputer 500 and various types of data. The microcomputer 500 performs various types of processing mentioned above with reference to FIG. 3, display control of the television picture based on the display control signal, and the like, by executing the programs held in the memory 600.

The display control signal obtainment unit 750 is a filtering circuit for extracting the display control signal from the control stream outputted from the TS decoder 230 to the microcomputer 500.

The display control signal 114 is a signal which is outputted from the television broadcasting apparatus to the television receiving apparatus and indicates whether or not to display the television picture in front of the WWW browser picture.

When the display control signal 114 indicates that the television picture is to be displayed in front of the browser picture, the microcomputer 500 instructs the picture combination unit 300 to combine the television picture and the WWW browser picture so that the television picture is displayed in front of the browser picture.

On the contrary, when the display control signal 114 indicates that the television picture is not to be displayed in front of the browser picture, the microcomputer 500 instructs the picture combination unit 300 to combine the television picture and the WWW browser picture so that the browser picture is displayed in front of the television picture, or only the browser picture is displayed.

The following describes a specific example of control of whether or not to display the television picture in front of the browser picture.

(During Broadcasting of a Commercial)

During the broadcast of a television program, the broadcast station wants the viewers to continue viewing the television program without switching the television picture display to the related WWW browser picture display.

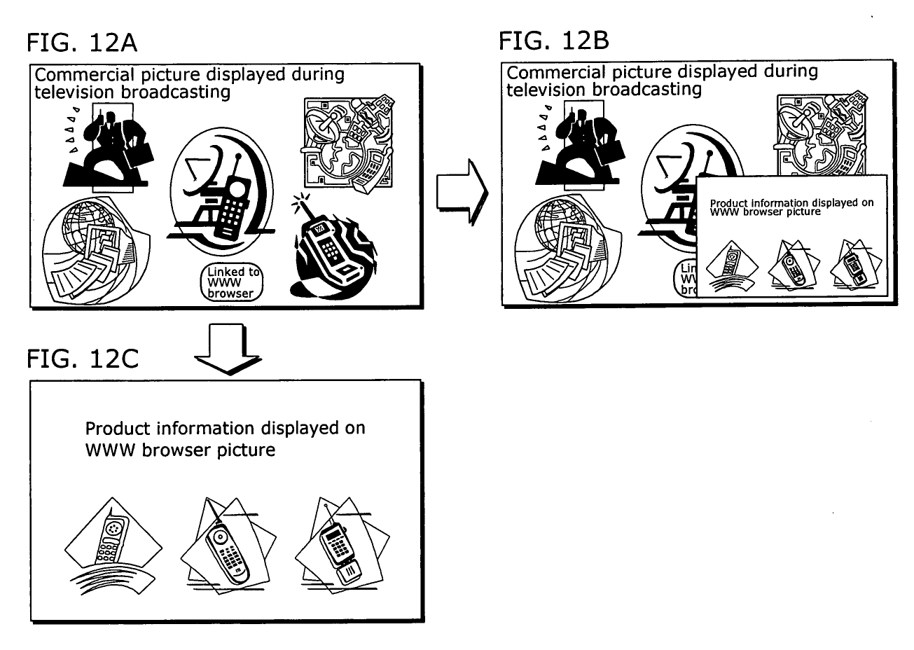

However, in the case where the viewer is interested in the product at which the commercial aims and wants to view more detailed information about the product on the WWW browser picture than the commercial information, it is possible to display the WWW browser picture in front of the television picture or to display only the WWW browser picture without displaying the television picture, because the display of the WWW browser picture serves the purpose of encouraging the viewer's willingness to buy the product at which the commercial aims. FIG. 12A to FIG. 12C show examples of commercial displays. In the case where WWW browser link information is displayed during broadcast of a commercial for a mobile phone as shown in FIG. 12A, “Linked to WWW browser” is displayed at the bottom of the screen. When a specific button of a remote control is pressed during this display, the display goes to the WWW browser link mode. In the WWW browser link mode, the WWW browser picture which contains the information of the mobile phone is displayed in front of the television picture as shown in FIG. 12B, or the only the WWW browser picture is displayed as shown in FIG. 12C.

(During Broadcasting of a Weather Report)

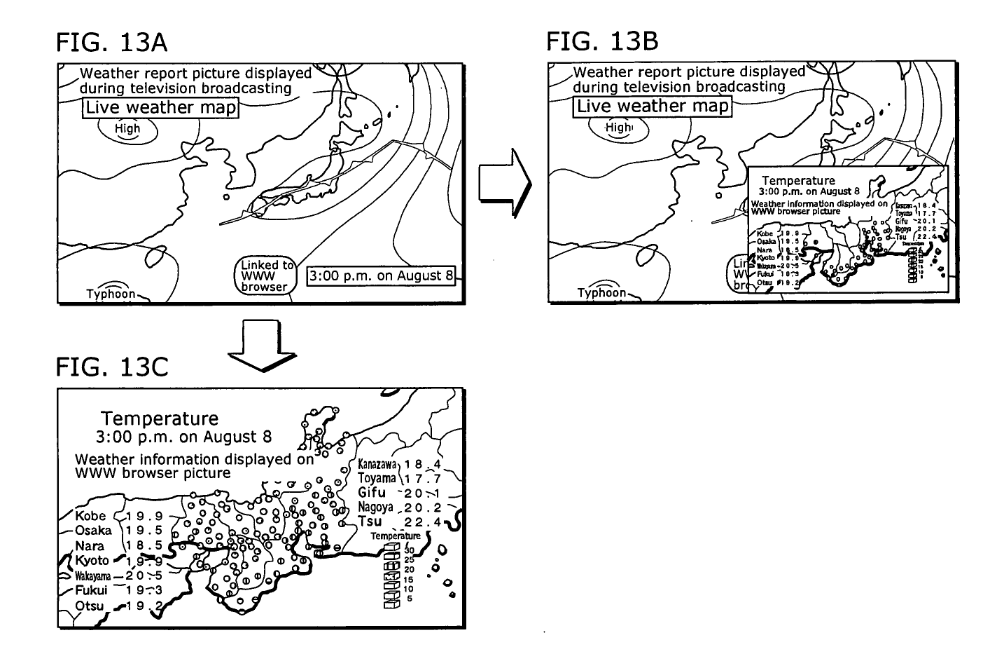

The case where a television program is a weather report will be explained as an exception to the front-displaying of the television picture. In the case of the weather report, the national forecast, local forecast and weekly forecast are reported in sequence. However, the viewer must want to know the information of his/her own interest directly and as early as possible. By providing the forecast of the region of the user's interest in the WWW browser display mode in the case of the weather report, the user can view directly the information of his/her interest, regardless of the sequence of the weather reports as a television program, which offers convenience to the user. In addition, the television picture does not need to be always displayed in front of the browser picture. The information that the viewer wants to know can be displayed more easily by displaying the WWW browser picture in front of the browser picture in its entirety or displaying the WWW browser picture only. FIG. 13A to FIG. 13C are examples of weather report displays. In the case where there is WWW browser link information during broadcast of a weather report indicating a live weather map as shown in FIG. 13A, “Linked to WWW browser” is displayed on the bottom of the screen. By pressing a specific button of a remote control during this display, the picture display mode goes to the WWW browser link mode. In the WWW browser link mode, the weather information on the WWW browser picture that the viewer wants to see earlier is displayed in front of the television picture as shown in FIG. 13B, or only the WWW browser picture is displayed as shown in FIG. 13C.

It should be noted that the display of the above link information is not limited to “Linked to WWW browser” as shown in FIG. 12A or FIG. 13A. For example, any expression that shows appropriately that the viewers can move to the WWW browser mode, such as “Browser Mode”, can be displayed.

In this case, a specific button of a remote control is pressed when “Linked to WWW browser” is displayed, but the present invention is not limited to that case. For example, it is possible to add a voice recognition function to a receiver and move to the WWW browser link mode when the viewer instructs “Move” by voice during the display of “Linked to WWW browser”.

Another example of canceling the front-displaying of the television picture is the case of emergency broadcast. For example, in the case where the television broadcast is switched to the emergency broadcast, the front-displaying control of the television picture is cancelled. Then, it is controlled so that the link information related to the emergency broadcast (on the WWW browser picture) is displayed in front of any other pictures on the screen, or only the WWW browser picture is displayed. By doing so, more detailed information related to the television broadcast can be provided to the users, which provides advantages for them.

As described above, the present invention allows the television station to control, dependent upon the contents of the television broadcast, whether or not to display the television picture in front of the WWW browser picture while maintaining the entirety of the television picture. According to this invention, it becomes possible to perform front-displaying control of a television picture as appropriate, in consideration of both the intention on the program production part and the viewer convenience.

Next, the front-displaying control of the television picture will be explained specifically.

First, the display style and stacking of layers of pictures will be explained.

A style sheet language, such as CSS2, which is on public as a W3C (World Wide Web Consortium) Recommendation, can be used to set a style (such as a font, character spacing and voice input) for a WWW browser picture, that is, a structured document written in HTML, XML and the like.

In CSS2, boxes (windows) that make up WWW browser picture have respective positions (coordinates) in a 3D space. Each box is represented by a position on the “z-axis” as well as a horizontal position (on the x-axis) and a vertical position (on the y-axis), and a box is placed in front of another box. Particularly when the boxes overlap each other from the user's viewpoint, the z-axis takes on the meaning.

The front-displaying of a specific box, a television broadcast picture in this case, means that the box is closer to the user along the z-axis in terms of a stacking concept, when the user faces the picture. The z-axis indicates an axis from the screen to the reader.

In order to define stacking of pictures displayed in the WWW browser picture mode, stack levels of the pictures are specified. A box with a higher stack level is displayed in front (closer to the user) of boxes with lower stack levels (further away from the user).

In the case where boxes with the same stack level overlap each other, a box which appears later on a source is displayed in front of the earlier one.

To be more accurately, the relative coordinate of a box on the z-axis to which the box belongs (i.e., the stacking context) is specified. The root element creates a root stacking context (“0” on the z-axis, for example).

When “z-index: 1” is assigned to a parent box, the box is placed at the position “1” on the z-axis. When “z-index: −1” is assigned to a child box contained in the parent box, the parent box functions as a staking context, and the child box is placed on the position “0” (1-1), relative to the parent box, on the z-axis. Namely, the child box is displayed behind the parent box and on (in front of) the root box in the stacking order.

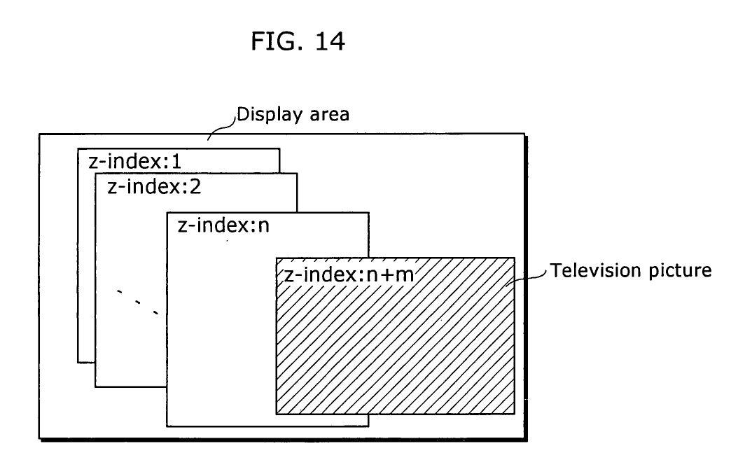

FIG. 14 shows an example of how stack levels are assigned to boxes. Assuming that “z-index: 1” to “z-index: n” (n is an integer) are assigned to the WWW browser pictures, as shown in FIG. 14, a television broadcast picture is displayed in front of the browser pictures by assigning it “z-indx: n+m” (both n and m are integers, and m is 1 or larger). However, it should be noted that the property of the z-index value does not indicate the absolute coordinate on the z-axis but the relative coordinate thereon.

As shown in FIG. 14, the maximum z-index value for the WWW browser pictures is “n” (n is an integer). However, since the related WWW browser picture varies from program to program, this maximum z-index value “n” also varies from program to program.

Therefore, the maximum z-index value relative to the reference layer (z-index: 0) for the WWW browser pictures or the number of layers “n” (n is an integer) of the such pictures is extracted for each related program, and this extracted value is considered to be the “x-index” value of the front one among the browser pictures only, namely, the maximum “z-index” value. It is possible to control the picture display so that the television broadcast picture is displayed in front of the browser pictures by setting the “z-index” value of the television picture to be larger than the maximum “z-index” value of the WWW browser pictures. In FIG. 14, the “z-index” value of the television broadcast picture is n+m (n and m are integers), and the value of “m” is 1 or a larger integer. It is desirable to set the z-index value of the television picture to be much larger than the maximum z-index value of the WWW browser picture. For example, if the value “m” is set to be 100 or so for the television picture, it becomes possible to make fairly certain that the television picture is displayed in front of any other pictures, even if the value “n” (n is an integer) as the maximum “z-index” value of the WWW browser picture or the number of layers of the WWW browser pictures are not extracted every time the maximum “z-index” value fluctuates a little due to the switching between the WWW browser pictures.

Next, the stacking of a television picture controlled according to the display control signal 114 will be explained.

As shown in FIG. 11, the display control signal 114 is multiplexed on the television broadcast signal by the television broadcasting apparatus 1. The TS decoder 230 performs filtering processing, according to the MPEG standard, on the transport stream outputted from the tuner 220. As a result of the filtering processing, the transport stream is separated into an audio stream, a video stream and a control stream that includes the packets related to data broadcasting, browser control data and display control signal.

The display control signal 114 is extracted from the control stream by the display control signal obtainment unit 750 and then transmitted to the control microcomputer 500.

In the case where the control microcomputer 500 receives the browser display instruction obtained by the browser display instruction obtainment unit 710, it obtains the WWW browser display data based on the URL obtained by the URL obtainment unit 720.

Then, the control microcomputer 500 extracts the value “n” (n is an integer), as the maximum “z-index” value relative to the z-index value (“z-index: 0”) of the reference layer that is the reference to the obtained WWW browser display data or the number of layers of the WWW browser pictures, considers it as the maximum z-index value “n” (n is an integer), and holds it in the storage unit (not shown in the diagram) included in itself.

When the display control signal (an indication signal: IS) indicates that the television picture is to be displayed in front of the WWW browser pictures, the control microcomputer 500 determines that “IS=11” and the z-index value of the television picture is “n+m” (n and m are integers and 1≦m, for example, m=100).

As a result, the television picture is displayed in front of any other pictures.

When the display control signal (IS) indicates that the television picture is to be displayed behind the WWW browser picture, the control microcomputer 500 determines that “IS=01” and the z-index value of the television picture is “n+m” (n and m are integers and n−m≦0), for example, m=n.

As a result, the television picture is displayed behind the WWW browser picture.

When the display control signal (IS) indicates that only the WWW browser picture is displayed, the control microcomputer 500 determines “IS=00”, and controls so as to display only the WWW browser picture by clearing the television picture data in the picture combination unit 300. For that purpose, it may control so as to display the WWW browser picture in full picture mode by changing the setting of the fixed scaling 340 for the WWW browser picture.

The above description is the case where it is controlled so as to display the television picture in front of the browser picture based on the display control signal which is multiplexed on the television broadcast signal in the television broadcasting apparatus 1. However, in the case where the television broadcasting apparatus 1 does not support the front-displaying of the television picture, it is also possible to control the front-displaying of the television picture by the user's instruction using a remote control or the like. To be more specific, it is possible to control the front-displaying of the television picture by adding the control function for displaying the television picture in front of any other pictures on the screen to the television receiver 2 and inputting the value of the display control signal (IS), e.g., “11”, “01” or “00”, using a remote control (not shown in the diagram). By doing so, it becomes possible for the user to easily specify the stack level of the picture that he/she wants to display in front of any other pictures on the screen using a remote control, on the television receiver without a pointing device such as a mouse for a personal computer.

The present embodiment describes the case where the display style information is previously held in the television receiver, but the present invention is not limited to that case. For example, as disclosed in the prior art (Japanese Laid-Open Patent Application No. 2003-78837), the display style for TV program-linked display may be specified based on the display style information transmitted from the television broadcasting apparatus.

Furthermore, the present embodiment describes the case where the television picture is controlled so as to be displayed in front of the browser pictures by determining the stack levels thereof to be displayed on the screen in the WWW browser mode. However, it is also possible to switch, based on the front-displaying control signal, the display style information from among a plurality of previously stored style information for display patterns to be controlled, for example, the style information for usual television display, the style information for front-displaying of the television picture in the case of the combined display of both the television picture and browser picture, the style information for front-displaying of the WWW browser picture in the case of the combined display of both the television picture and browser picture, the style information for display of only the WWW browser picture, and the like. Even in this case, the television picture can be controlled so as to be displayed in front of any other pictures on the screen.

### Second Embodiment

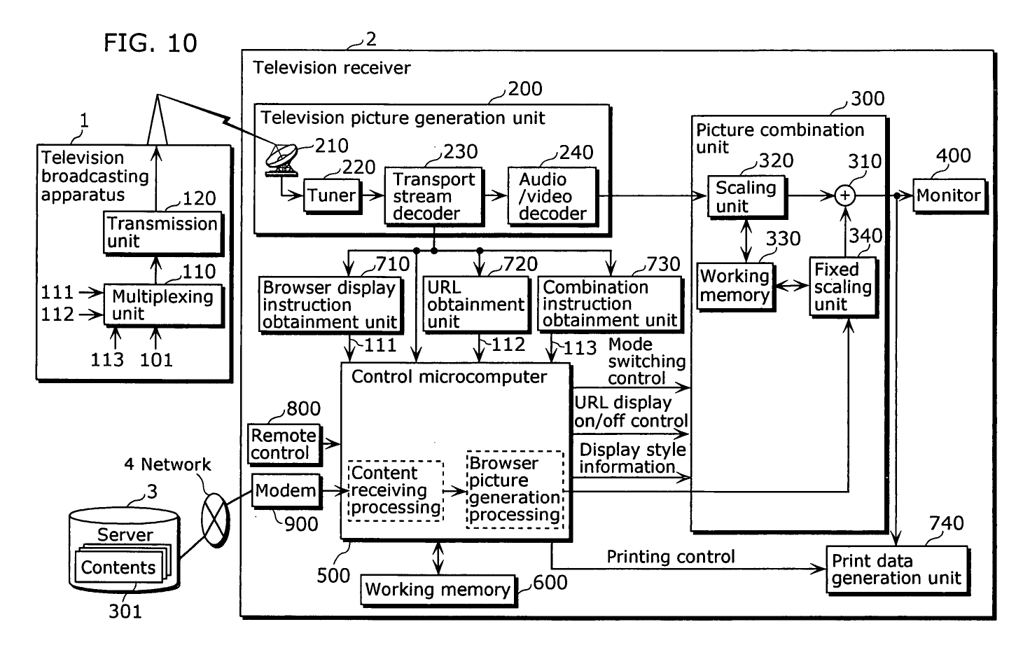

In the second embodiment, an example where whether or not to print the data to be displayed on the screen is controlled based on the combination information used for controlling whether or not to combine the browser picture and the broadcast-type picture in the first embodiment will be explained with reference to FIG. 10.

FIG. 10 is a block diagram showing a configuration of a television broadcasting apparatus and a television receiver according to the second embodiment of the present invention. Here, the same reference numbers are assigned to the same components as those in the block diagram in FIG. 3 showing the television broadcasting apparatus and the television receiver in the first embodiment, and the explanation thereof is not repeated here.

The newly added components in FIG. 10 in the second embodiment will be explained below.

Here, the newly added combination information 113 is inputted to the multiplexing unit 110 of the television broadcasting apparatus 1.

The control stream separated through the filtering processing performed by the TS decoder 230 of the television receiver 2 is inputted to the combination information obtainment unit 730 which is newly added in the second embodiment.

The combination information obtainment unit 730 extracts the combination information from the control stream and transmits it to the microcomputer 500.

The microcomputer 500 controls whether or not to cause the print data generation unit 740, which is newly added in the second embodiment, to generate the print data based on the combination information.

The print data generation unit 740 receives the picture display data outputted from the picture combination unit 300, and generates the print data based on the picture display data.

According to the second embodiment, it is possible to disable the printing of only the television picture and control the printing of the television picture so that the print data is generated only when the television picture and the browser picture are combined, namely, the combination information indicates the combination of them.

The second embodiment describes the example where whether or not to print the data to be displayed on the screen is controlled based on the combination information, but it is also possible to control the printing of data, based on the browser display instruction 111, not on the combination information, so that the data to be displayed on the screen can be printed when the browser picture is displayed. In other words, it is possible to control the printing of data so as to enable the printing of the television picture when the WWW browser picture is displayed in conjunction with the television picture.

In the case where the television picture is printed even when the WWW browser picture is not displayed in conjunction with the television picture, it is possible to enable the printing of the television picture by combining the television picture with the commercial of the sponsor company of the television picture displayed during broadcasting of a television program. The commercials to be combined in such a case include the WWW browser picture related to the program and the television broadcast picture inserted during the current program. In the case of the WWW browser picture, the URL of the WWW browser picture related to the program is obtained from the television broadcasting apparatus when the printing instruction of the television picture is received. Even in the case of the television commercial inserted into the current television program, if the commercial information is previously broadcasted on the television broadcast, filtered and then stored in the storage unit of the television receiver 2, that commercial information stored in the storage unit is used. In the case where there is no such commercial information, the commercial information may be obtained by requesting the television broadcasting apparatus for that information after receipt of the printing instruction. As mentioned above, if the printing of the television picture is enabled only when it is combined with the related commercial information, the advertising effectiveness can be enhanced.

Although only some exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

The present invention is of value as an STB (Set Top Box) and a television receiving apparatus having a function of receiving television broadcast or the like and communicating it via a communication network such as the Internet as well as a TV program-linked display function of displaying a browser picture in conjunction with a television picture with the entirety of the television picture being maintained. In addition, the present invention is applicable to a computer, a personal digital assistant and the like having a television receiving function.

1. A receiving apparatus that receives a plurality of information in different formats from different sources and displays the plurality of information, comprising:
a first receiving unit operable to receive at least one first information that includes link information that indicates a location where second information related to the first information is stored;
a displaying unit operable to display the received plurality of information on a single screen;
a second receiving unit operable to receive the second information from the storage location indicated by the link information included in the displayed first information; and
a control unit operable to change a size of a first information picture to a predetermined size, and control the displaying unit so as to continue displaying the first information picture, as a window on the single screen, in front of a second information picture, the first information picture being a picture displayed as the first information, and the second information picture being a picture displayed simultaneously as the received second information.

2. The receiving apparatus according to claim 1,
wherein in the case where the second information is a structured document written in a language including HTML and XML and a display style of the first information and the second information is determined by specifying stack levels of the first information picture and the second information picture on the screen using a style sheet language including Cascading Style Sheets, Level 2, the control unit controls the displaying unit so that the stack level of the first information picture is larger than all the stack levels of the second information pictures on the screen.

3. The receiving apparatus according to claim 2,
wherein the stack levels are specified so that an integer “n” is larger than an integer “m” where “n” is a maximum value of a z-index property of the second information picture and “m” is a value of a z-index property of the first information picture.

4. The receiving apparatus according to claim 1,
wherein the first receiving unit further receives a display control signal for controlling whether or not to display the first information in front of any other pictures on the screen, and
the control unit causes the displaying unit to continue displaying the first information in front of any other pictures on the screen when the display control signal received from the first receiving unit indicates that the first information is to be displayed in front of any other pictures on the screen.

5. The receiving apparatus according to claim 4, further comprising
a storage unit operable to hold style information for front-displaying a television picture and one or more different types of other style information,
wherein the control unit selects the style information for front-displaying the television picture and controls display of the television picture on the screen.

6. The receiving apparatus according to claim 4,
wherein the first receiving unit receives the first information and the display control signal via broadcast airwaves,
the second receiving unit receives the second information from the storage location via a communication network,
the control unit includes:
a style information storage unit operable to previously hold second style information for placing the first information picture of the predetermined size in front of the received second information picture;
a display size changing unit operable to change the size of the first information picture to the predetermined size based on the second style information; and
a combination unit operable to generate a display picture by combining the first information picture of the predetermined size with the second information picture based on the second style information, and
the control unit causes the displaying unit to display the display picture generated by the combination unit when the received display control signal indicates that the first information is to be displayed in front of the second information.

7. The receiving apparatus according to claim 6,
wherein the control unit controls the displaying unit so as to display the first information in front of the second information in the case where a television program as the first information is broadcasted without interruption.

8. The receiving apparatus according to claim 6,
wherein the control unit controls the displaying unit so as to display the first information behind the second information or display only the second information while a commercial as the first information is being broadcasted.

9. The receiving apparatus according to claim 1, further comprising
a switching instruction input unit operable to accept a user's input that instructs switching between a normal display mode and a combined display mode, the normal display mode being a mode in which the displaying unit is caused to display only the received first information, and the combined display mode being a mode in which the displaying unit is caused to display selected second information behind the first information picture of the predetermined size when accepting the user's input that indicates selection of the second information to be received,
wherein the control unit switches between the normal display mode and the combined display mode according to the switching instruction, and causes the displaying unit to display the second information behind the first information in the case where the second information to be received is selected in the combined display mode.

10. The receiving apparatus according to claim 1,
wherein the first receiving unit receives the first information and first style information for placing the first information picture on the screen in full-screen mode via broadcast airwaves,
the second receiving unit receives the second information from the storage location via a communication network,
the control unit includes:
a style information holding unit operable to previously hold second style information for placing the first information picture of the predetermined size in front of the received second information picture;
a display size changing unit operable to change the size of the first information picture to the predetermined size based on the second style information; and
a combination unit operable to generate a display picture by combining the first information picture of the predetermined size with the second information picture based on the second style information, and
the control unit causes the displaying unit to display the display picture generated by the combination unit.

11. The receiving apparatus according to claim 10,
wherein the first receiving unit receives the plurality of first information in order of time,
the first style information indicates that a main picture is placed on the screen in full-screen mode, while a sub-picture is placed, as a window on the screen, in an area within the main picture and in front of the main picture, the main picture being one of the first information that is currently being received, and the sub-picture being another one of the first information that was displayed in the past,
the second style information indicates that a main picture is placed on the screen in full-screen mode, while a plurality of sub-pictures are placed, as windows on the screen, in areas within the main picture which do not overlap each other and in front of the main picture, the main picture being the received second information, and the plurality of sub-pictures being the plurality of first information, and
the combination unit changes only the main picture to a picture of another newly received second information in the case where said another second information is received based on the link information of any of the first information displayed as the sub-pictures when the second information as the main picture is displayed based on the second style information.

12. The receiving apparatus according to claim 11,
wherein a part of the first information displayed in the past is a moving image which was being displayed for a predetermined period of time.

13. The receiving apparatus according to claim 11,
wherein a part of the first information displayed in the past is the link information.

14. The receiving apparatus according to claim 10,
wherein the first receiving unit receives the plurality of first information on different carrier waves,
the first style information indicates that a main picture is placed on the screen in full-screen mode, while a sub-picture is placed, as a window on the screen, in an area within the main picture and in front of the main picture, the main picture being a predetermined one of the first information, and the sub-picture being another first information than the predetermined first information,
the second style information indicates that a main picture is placed on the screen in full-screen mode, while a plurality of sub-pictures are placed, as windows on the screen, in areas within the main picture which do not overlap each other and in front of the main picture, the main picture being the received second information, and the plurality of sub-pictures being the plurality of the first information, and
the combination unit changes only the main picture as another newly received second information in the case where said another second information is received based on the link information of any of the first information displayed as the sub-pictures when the second information as the main picture is displayed based on the second style information.

15. The receiving apparatus according to claim 10, further comprising:
a print data generation unit operable to generate print data from the display picture generated by the combination unit; and
a printing control unit operable to control the generation of the print data by the print data generation unit based on a printing instruction from a user.

16. The receiving apparatus according to claim 15, further comprising:
a holding unit operable to hold a television picture upon receipt of the printing instruction of the television picture as the first information from the user; and
a commercial information obtaining unit operable to obtain commercial information of a sponsor who is involved in the held television picture,
wherein the print data generation unit generates the print data from picture data obtained by combining the television picture held in the holding unit and a picture of the commercial information obtained by the commercial information obtaining unit.

17. The receiving apparatus according to claim 16,
wherein the commercial information obtaining unit extracts the commercial information from a television signal which has been received before the receipt of the printing instruction.

18. The receiving apparatus according to claim 16,
wherein the commercial information obtaining unit obtains the commercial information by requesting a television broadcasting apparatus for said commercial information after the receipt of the printing instruction.

19. The receiving apparatus according to claim 16,
wherein the commercial information obtaining unit obtains Web information related to television broadcast instead of the commercial information related to said television broadcast after the receipt of the printing instruction.

20. The receiving apparatus according to claim 15,
wherein the first information further includes combination information that indicates whether or not to combine the first information with the second information, and
the printing control unit controls the generation of the print data by the print data generation unit based on the printing instruction from the user in the case where the combination information indicates that the first information is to be combined with the second information.

21. The receiving apparatus according to claim 10,
wherein the first information further includes combination information that indicates whether or not to combine the first information with the second information, and
the combination unit combines said at least one first information with the second information so that the first information picture is placed, as a window on the screen, in an area within the second information picture in the case where the combination information indicates said at least one first information is to be combined with the second information.

22. The receiving apparatus according to claim 1,
wherein the link information is a URL.

23. A method for receiving a plurality of information in different formats from different sources and displaying the plurality of information in conjunction with each other, comprising:
a first receiving step of receiving at least one first information that includes link information that indicates a location where second information related to the first information is stored;
a first displaying step of displaying the received plurality of information on a single screen;
a second receiving step of receiving the second information from the storage location indicated by the link information included in the displayed first information; and
a second displaying step of changing a size of a first information picture to a predetermined size, and continuing displaying the first information picture, as a window on the screen, in front of a second information picture, the first information picture being a picture displayed as the first information, and the second information picture being a picture displayed simultaneously as the received second information.

24. The method according to claim 23, further comprising
a switching instruction inputting step of accepting a user's input that instructs switching between a normal display mode and a combined display mode, the normal display mode being a mode for displaying only the received first information, and the combined display mode being a mode for displaying selected second information behind the first information picture of a predetermined size when accepting the user's input that indicates selection of the second information to be received,
wherein in the second displaying step, the normal display mode and the combined display mode are switched according to the switching instruction, and the second information is displayed behind the first information in the case where the second information to be received is selected in the combined display mode.

25. The method according to claim 23,
wherein second style information for placing the first information picture of the predetermined size in front of the received second information picture is previously stored in a memory,
in the first receiving step, the first information and first style information for placing the first information picture on the screen in full-screen mode is received via broadcast airwaves,
in the second receiving step, the second information is received from the storage location via a communication network,
the second displaying step includes:
a display size changing step of changing the size of the first information picture to the predetermined size based on the second style information; and
a combination step of generating a display picture by combining the first information picture of the predetermined size with the second information picture based on the second style information, and
in the second displaying step, the display picture generated in the combination step is displayed.

26. The method according to claim 25,
wherein in the first receiving step, the plurality of first information are received in order of time,
the first style information indicates that a main picture is placed on the screen in full-screen mode, while a sub-picture is placed, as a window on the screen, in an area within the main picture and in front of the main picture, the main picture being one of the first information that is currently being received, and the sub-picture being another one of the first information that was displayed in the past,
the second style information indicates that a main picture is placed on the screen in full-screen mode, while a plurality of sub-pictures are placed, as windows on the screen, in areas within the main picture which do not overlap each other and in front of the main picture, the main picture being the received second information, and the plurality of sub-pictures being the plurality of first information, and
in the combination step, only the main picture is changed to a picture of another newly received second information in the case where said another second information is received based on the link information of any of the first information displayed as the sub-pictures when the second information as the main picture is displayed based on the second style information.

27. The method according to claim 26,
wherein the first information further includes combination information that indicates whether or not to combine the first information with the second information, and
in the combination step, said at least one first information is combined with the second information so that the first information picture is placed, as a window on the screen, in an area within the second information picture in the case where the combination information indicates said at least one first information is to be combined with the second information.

28. The method according to claim 25,
wherein in the first receiving step, the plurality of first information are received on different carrier waves,
the first style information indicates that a main picture is placed on the screen in full-screen mode, while a sub-picture is placed, as a window on the screen, in an area within the main picture and in front of the main picture, the main picture being a predetermined one of the first information, and the sub-picture being another first information than the predetermined first information,
the second style information indicates that a main picture is placed on the screen in full-screen mode, while a plurality of sub-pictures are placed, as windows on the screen, in areas within the main picture which do not overlap each other and in front of the main picture, the main picture being the received second information, and the plurality of sub-pictures being the plurality of the first information, and
in the combination step, only the main picture as another newly received second information is changed in the case where said another second information is received based on the link information of any of the first information displayed as the sub-pictures when the second information as the main picture is displayed based on the second style information.

29. The method according to claim 25, further comprising
a print data generation step of generating print data from the display picture generated in the combination step based on a printing instruction from a user.

30. The method according to claim 29,
wherein the first information further includes combination information that indicates whether or not to combine the first information with the second information, and
in the print data generation step, the print data is generated based on the printing instruction from the user in the case where the combination information indicates that the first information is to be combined with the second information.

31. A printing control method for receiving a plurality of information in different formats from different sources and displaying the plurality of information, and printing a display picture, comprising:
a first receiving step of receiving at least one first information that includes link information that indicates a location where second information related to the first information is stored;
a first displaying step of displaying the received plurality of information on a single screen;
a second receiving step of receiving the second information from the storage location indicated by the link information included in the displayed first information;
a display size changing step of changing a size of a first information picture to a predetermined size based on second style information which is previously stored in a memory, the second style information indicating that the first information picture of the predetermined size is to be displayed, as a window on the single screen, in front of a second information picture, the first information picture being a picture displayed as the first information, and the second information picture being a picture displayed simultaneously as the received second information;
a combination step of generating the display picture by combining the first information picture of the predetermined size with the second information picture based on the second style information,; and
a print data generation step of generating print data from the display picture generated in the combination step based on a printing instruction from a user.

32. The printing control method according to claim 31,
wherein the first information further includes combination information that indicates whether or not to combine the first information with the second information, and
in the combination step, said at least one first information is combined with the second information so that the first information picture is placed, as a window on the screen, in an area within the second information picture in the case where the combination information indicates said at least one first information is to be combined with the second information.

33. A program for a method for receiving a plurality of information in different formats from different sources and displaying the plurality of information in conjunction with each other, the program causing a computer to execute:
a first receiving step of receiving at least one first information that includes link information that indicates a location where second information related to the first information is stored;
a first displaying step of displaying the received plurality of information on a single screen;
a second receiving step of receiving the second information from the storage location indicated by the link information included in the displayed first information; and
a second displaying step of changing a size of a first information picture to a predetermined size, and continuing displaying the first information picture, as a window on the screen, in front of a second information picture, the first information picture being a picture displayed as the first information, and the second information picture being a picture displayed simultaneously as the received second information.
